(19) United States
(12) Patent Application Publication
(10) Pub. No.: US 2026/0260864 A1
(43) Pub. Date: Sep. 3, 2026

(54) SYSTEM AND METHOD FOR DETERMINING ION CHARGE AND FREQUENCY IN A CHARGE DETECTION MASS SPECTROMETER

(71) Applicant: THE TRUSTEES OF INDIANA UNIVERSITY, Bloomington, IN (US)

(72) Inventors: Raj PARIKH, Bloomington, IN (US); Martin F. JARROLD, Bloomington, IN (US)

(21) Appl. No.: 19/531,148

(22) Filed: Feb. 5, 2026

Related U.S. Application Data
(60) Provisional application No. 63/755,372, filed on Feb. 7, 2025.

(51) Int. Cl. H01J 49/02; H01J 49/42

(52) U.S. Cl. CPC H01J 49/027; H01J 49/4245; H01J 49/425

(57) ABSTRACT

A method is provided for operating a charge detection mass spectrometer, and includes trapping multiple ions so as to oscillate back and forth through or about a charge detector during an ion trapping event, collecting charge detection data resulting from detection of charges induced by the multiple ions on the charge detector, processing the collected charge detection data with a first short-time overlapping Fourier transform (STFT1) process optimized for oscillating frequency determination precision to determine oscillating frequencies of each of the multiple trapped ions, processing the collected charge detection data with a second short-time overlapping Fourier transform (STFT2) process optimized for charge magnitude determination precision to determine charge magnitudes of each of the multiple trapped ions, populating a filtered file with associated pairs of at least some of the determined oscillating frequencies and determined charge magnitudes, and producing a spectral distribution from the filtered file.

### CROSS-REFERENCE TO RELATED APPLICATION

This patent application claims the benefit of, and priority to, U.S. Provisional Patent Application Ser. No. 63/755,372, filed Feb. 7, 2025, the disclosure of which is incorporated herein by reference in its entirety.

### GOVERNMENT RIGHTS

This invention was made with government support under GM131100 awarded by the National Institutes of Health. The United States Government has certain rights in the invention.

### TECHNICAL FIELD

The present disclosure relates generally to charge detection mass spectrometry (CDMS) including a charged particle detector in the form of a charged particle trap in which multiple charged particles are simultaneously trapped and measured, and more specifically to systems and techniques for determining ion charge and frequency of each of the multiple trapped charged particles.

### BACKGROUND

Charge detection mass spectrometry (CDMS) is a charged particle analysis technique in which masses of individual charged particles are determined from simultaneous measurements of their mass-to-charge ratios (m/z) and charge magnitudes (z). Charged particles are trapped in an electrostatic linear ion trap or an orbitrap, and measurements are made of charges induced by the charged particles on a charge detector as they oscillate back and forth through or about the charge detector for the duration of the trapping event. Simultaneously trapping multiple charged particles can significantly increase CDMS throughput and thereby reduce analysis time, although this approach can lead to increased rejection of charged particle measurement information from the analysis results, as compared with that of single particle analysis techniques, due to errors in determination of the charge magnitude and/or in determination of the oscillating frequency.

### SUMMARY

The present disclosure may comprise one or more of the features recited in the attached claims, and/or one or more of the following features and combinations thereof. In a first aspect, a method is provided for operating a charge detection mass spectrometer including an electrostatic linear ion trap (ELIT) or an orbitrap. The method may comprise (i) trapping multiple ions, generated from a sample, in the ELIT or orbitrap such that the multiple trapped ions oscillate back and forth through or about a charge detector of the ELIT or orbitrap during an ion trapping event, (ii) collecting charge detection data resulting from detection of charges induced by the multiple ions on the charge detector over the ion trapping event, (iii) processing the collected charge detection data with a first short-time overlapping Fourier transform (STFT1) process optimized for oscillating frequency determination precision to determine oscillating frequencies of each of the multiple trapped ions, (iv) processing the collected charge detection data with a second short-time overlapping Fourier transform (STFT2) process optimized for charge magnitude determination precision to determine charge magnitudes of each of the multiple trapped ions, (v) populating a filtered file with associated pairs of at least some of the determined oscillating frequencies and determined charge magnitudes, and (vi) producing a spectral distribution from the filtered file of oscillating frequency and charge magnitude pairs.

A second aspect includes the features of the first aspect, and may further comprise executing (i)-(v) multiple times, followed by executing (vi) using the filtered file containing oscillating frequency and charge magnitude pairs for all of the multiple executions of (i)-(v).

A third aspect includes the features of the first or second aspects, and may further comprise, prior to executing (iii) and (iv), selecting for the STFT1 process a first apodization method configured to optimize the STFT1 process for oscillating frequency determination precision, and selecting for the STFT2 process a second apodization method configured to optimize the STFT2 process for ion charge magnitude determination precision, wherein (iii) comprises computing a series of STFT1s each with the STFT1 process stepped sequentially through the collected charge detection data using the first apodization method, and determining the oscillating frequencies of each of the multiple trapped ions from the computed series of STFT1s, and wherein (iv) comprises computing a series of STFT2s with the STFT2 process stepped sequentially through the collected charge detection data using the second apodization method, and determining the charge magnitudes of each of the multiple trapped ions from the computed series of STFT2s.

A fourth aspect includes the features of the third aspect, and wherein the first apodization method is different from the second apodization method.

A fifth aspect includes the features of the third aspect, and wherein the first apodization method is the same as the second apodization method.

A sixth aspect includes the features of the any of the third through fifth aspects, and wherein the first and second apodization methods are each selected from a group consisting of a Gaussian apodization method, a rectangle apodization method, a Blackman Harris apodization method, and a flat-top apodization method.

A seventh aspect includes the features of any of the third through sixth aspects, and may further comprise, prior to executing (iii) and (iv), selecting for the STFT1 process a first window step size configured to optimize the STFT1 process for oscillating frequency determination precision, and selecting for the STFT2 process a second window step size configured to optimize the STFT2 process for ion charge magnitude determination precision, wherein (iii) comprises computing the series of STFT1s with the STFT1 process stepped sequentially through the collected charge detection data using the first apodization method with the first window step size, and determining the oscillating frequencies of each of the multiple trapped ions from the computes series of STFT1s, and wherein (iv) comprises computing the series of STFT2s with the STFT2 process stepped sequentially through the collected charge detection data using the second apodization method with the second window step size, and determining the charge magnitudes of each of the multiple trapped ions from the computed series of STFT2s.

An eighth aspect includes the features of the seventh aspect, and wherein the first window step size is different from the second window step size.

A ninth aspect includes the features of the seventh aspect, and wherein the first window step size is the same as the second window step size.

A tenth aspect includes the features of any of the third through ninth aspects, and may further comprise, prior to executing (iii) and (iv), selecting for the STFT1 process a first window length configured to optimize the STFT1 process for oscillating frequency determination precision, and selecting for the STFT2 process a second window length configured to optimize the STFT2 process for ion charge magnitude determination precision, wherein (iii) comprises computing the series of STFT1s with the STFT1 process stepped sequentially through the collected charge detection data using the first apodization method with the first window step size and with the first window length, and determining the oscillating frequencies of each of the multiple trapped ions from the computed series of STFT1s, and wherein (iv) comprises computing the series of STFT2s with the STFT2 process stepped sequentially through the collected charge detection data using the second apodization method with the second window step size and with the second window length, and determining the charge magnitudes of each of the multiple trapped ions from the computed series of STFT2s

An eleventh aspect includes the features of the tenth aspect, and wherein the first window length is longer than the second window length.

A twelfth aspect includes the features of the tenth aspect, and wherein the first window length is (a) at least twice as long as the second window length, (b) at least three times longer than the second window length, or (c) at least four times longer than the second window length.

A thirteenth aspect includes the features of the first or second aspect, an may further comprise, prior to executing (iii) and (iv), selecting for the STFT1 process a first window step size configured to optimize the STFT1 process for oscillating frequency determination precision, and selecting for the STFT2 process a second window step size configured to optimize the STFT2 process for charge magnitude determination precision, wherein (iii) comprises computing a series of STFT1s with the STFT1 process stepped sequentially through the collected charge detection data using the first window step size, and determining the oscillating frequencies of each of the multiple trapped ions from the computed series of STFT1s, and wherein (iv) comprises computing a series of STFT2s with the STFT2 process stepped sequentially through the collected charge detection data using the second window step size, and determining the charge magnitudes of each of the multiple trapped ions from the computed series of STFT2s.

A fourteenth aspect includes the features of the thirteenth aspect, and wherein the first window step size is different from the second window step size.

A fifteenth aspect includes the features of the thirteenth aspect, and wherein the first window step size is the same as the second window step size.

A sixteenth aspect includes the features of the first or second aspect, and may further comprise, prior to executing (iii) and (iv), selecting for the STFT1 process a first window length configured to optimize the STFT1 process for oscillating frequency determination precision, and selecting for the STFT2 process a second window length configured to optimize the STFT2 process for charge magnitude determination precision, wherein (iii) comprises computing a series of STFT1s with the STFT1 process stepped sequentially through the collected charge detection data using the first window length, and determining the oscillating frequencies of each of the multiple trapped ions from the computed series of STFT1s, and wherein (iv) comprises computing a series of STFT2s with the STFT2 process stepped sequentially through the collected charge detection data using the second window length, and determining the charge magnitudes of each of the multiple trapped ions from the computed series of STFT2s

A seventeenth aspect includes the features of the sixteenth aspect, and wherein the first window length is longer than the second window length.

An eighteenth aspect includes the features of the sixteenth aspect, and wherein the first window length is (a) at least twice as long as the second window length, (b) at least three times longer than the second window length, or (c) at least four times longer than the second window length.

A nineteenth aspect includes the features of any of the first through eighteenth aspects, and wherein (iii) comprises computing a series of STFT1s with the STFT1 process stepped sequentially through the collected charge detection data, and determining from the computed series of STFT1s the oscillating frequencies of each of the multiple trapped ions and oscillation frequency standard deviations for each of the determined oscillating frequencies, and wherein (iv) comprises computing a series of STFT2s with the STFT2 process stepped sequentially through the collected charge detection data, and determining from the computed series of STFT2s the charge magnitudes of each of the multiple trapped ions, and charge magnitude standard deviations and harmonic ratios for each of the determined charge magnitudes.

A twentieth aspect includes the features of the nineteenth aspect, and wherein (v) comprises populating the filtered file only with associated pairs of the determined oscillating frequencies and determined charge magnitudes for which the corresponding oscillating frequency standard deviation is less than a first threshold value, the corresponding charge magnitude standard deviation is less than a second threshold value, and the corresponding harmonic ratio is within a threshold window of a target harmonic ratio value.

In a twenty first aspect, a charge detection mass spectrometer may comprise at least one ion processing stage configured receive ions generated from a sample, an electrostatic linear ion trap (ELIT) or an orbitrap positioned to receive the generated ions from the at least one ion processing stage, at least one memory, and at least one processor configured to execute instructions stored in the at least one memory to cause the at least one processor to (i) control the ELIT or orbitrap to trap multiple ones of the generated ions such that the multiple trapped ions oscillate back and forth through or about a charge detector of the ELIT or orbitrap during an ion trapping event, (ii) collect charge detection data resulting from detection of charges induced by the trapped multiple ions on the charge detector over the ion trapping event, (iii) process the collected charge detection data with a first short-time overlapping Fourier transform (STFT1) process optimized for oscillating frequency determination precision to determine oscillating frequencies of each of the multiple trapped ions, (iv) process the collected charge detection data with a second short-time overlapping Fourier transform (STFT2) process optimized for charge magnitude determination precision to determine charge magnitudes of each of the multiple trapped ions, (v) populate a filtered file with associated pairs of at least some of the determined oscillating frequencies and determined charge magnitudes, and (vi) produce a spectral distribution from the filtered file of oscillating frequency and charge magnitude pairs.

A twenty second aspect includes the features of the twenty first aspect, and may further comprise means for detecting charges induced by the trapped multiple ions on the charge detector of the ELIT or orbitrap.

A twenty third aspect includes the features of the twenty first or twenty second aspect, and wherein the instructions stored in the at least one memory include instructions executable by the at least one processor to cause the at least one processor to execute (i)-(v) multiple times, followed by executing (vi) using the filtered file containing oscillating frequency and charge magnitude pairs for all of the multiple executions of (i)-(v).

A twenty fourth aspect includes the features of any of the twenty first though twenty third aspects, and wherein the instructions stored in the at least one memory include instructions executable by the at least one processor to cause the at least one processor to, prior to executing (iii) and (iv), select for the STFT1 process a first apodization method configured to optimize the STFT1 process for oscillating frequency determination precision, and select for the STFT2 process a second apodization method configured to optimize the STFT2 process for ion charge magnitude determination precision, wherein the instructions stored in the at least one memory include instructions executable by the at least one processor to cause the at least one processor to execute (iii) by computing a series of STFT1s each with the STFT1 process stepped sequentially through the collected charge detection data using the first apodization method, and determining the oscillating frequencies of each of the multiple trapped ions from the computed series of STFT1s, and wherein the instructions stored in the at least one memory include instructions executable by the at least one processor to cause the at least one processor to execute (iv) by computing a series of STFT2s with the STFT2 process stepped sequentially through the collected charge detection data using the second apodization method, and determining the charge magnitudes of each of the multiple trapped ions from the computed series of STFT2s.

A twenty fifth aspect includes the features of the twenty fourth aspect, and wherein the instructions stored in the at least one memory include instructions executable by the at least one processor to cause the at least one processor to, prior to executing (iii) and (iv), select for the STFT1 process a first window step size configured to optimize the STFT1 process for oscillating frequency determination precision, and select for the STFT2 process a second window step size configured to optimize the STFT2 process for ion charge magnitude determination precision, wherein the instructions stored in the at least one memory include instructions executable by the at least one processor to cause the at least one processor to execute (iii) by computing the series of STFT1s each with the STFT1 process stepped sequentially through the collected charge detection data using the first apodization method with the first window step size, and determining the oscillating frequencies of each of the multiple trapped ions from the computed series of STFT1s, and wherein the instructions stored in the at least one memory include instructions executable by the at least one processor to cause the at least one processor to execute (iv) by computing the series of STFT2s with the STFT2 process stepped sequentially through the collected charge detection data using the second apodization method with the second window step size, and determining the charge magnitudes of each of the multiple trapped ions from the computed series of STFT2s.

A twenty sixth aspect includes the features of the twenty fourth or twenty fifth aspect, and wherein the instructions stored in the at least one memory include instructions executable by the at least one processor to cause the at least one processor to, prior to executing (iii) and (iv), select for the STFT1 process a first window length configured to optimize the STFT1 process for oscillating frequency determination precision, and select for the STFT2 process a second window length configured to optimize the STFT2 process for ion charge magnitude determination precision, wherein the instructions stored in the at least one memory include instructions executable by the at least one processor to cause the at least one processor to execute (iii) by computing the series of STFT1s each with the STFT1 process stepped sequentially through the collected charge detection data using the first apodization method with the first window length, and determining the oscillating frequencies of each of the multiple trapped ions from the computed series of STFT1s, and wherein the instructions stored in the at least one memory include instructions executable by the at least one processor to cause the at least one processor to execute (iv) by computing the series of STFT2s with the STFT2 process stepped sequentially through the collected charge detection data using the second apodization method with the second window length, and determining the charge magnitudes of each of the multiple trapped ions from the computed series of STFT2s.

A twenty seventh aspect includes the features of any of the twenty first through twenty third aspects, and wherein the instructions stored in the at least one memory include instructions executable by the at least one processor to cause the at least one processor to, prior to executing (iii) and (iv), select for the STFT1 process a first window step size configured to optimize the STFT1 process for oscillating frequency determination precision, and select for the STFT2 process a second window step size configured to optimize the STFT2 process for ion charge magnitude determination precision, wherein the instructions stored in the at least one memory include instructions executable by the at least one processor to cause the at least one processor to execute (iii) by computing a series of STFT1s each with the STFT1 process stepped sequentially through the collected charge detection data using the first window step size, and determining the oscillating frequencies of each of the multiple trapped ions from the computed series of STFT1s, and wherein the instructions stored in the at least one memory include instructions executable by the at least one processor to cause the at least one processor to execute (iv) by computing a series of STFT2s with the STFT2 process stepped sequentially through the collected charge detection data using the second window step size, and determining the charge magnitudes of each of the multiple trapped ions from the computed series of STFT2s.

A twenty eighth aspect includes the features of any of the twenty first through twenty third aspects, and wherein the instructions stored in the at least one memory include instructions executable by the at least one processor to cause the at least one processor to, prior to executing (iii) and (iv), select for the STFT1 process a first window length configured to optimize the STFT1 process for oscillating frequency determination precision, and select for the STFT2 process a second window length configured to optimize the STFT2 process for ion charge magnitude determination precision, wherein the instructions stored in the at least one memory include instructions executable by the at least one processor to cause the at least one processor to execute (iii) by computing a series of STFT1s each with the STFT1 process stepped sequentially through the collected charge detection data using the first window length, and determining the oscillating frequencies of each of the multiple trapped ions from the computed series of STFT1s, and wherein the instructions stored in the at least one memory include instructions executable by the at least one processor to cause the at least one processor to execute (iv) by computing a series of STFT2s with the STFT2 process stepped sequentially through the collected charge detection data using the second window length, and determining the charge magnitudes of each of the multiple trapped ions from the computed series of STFT2s.

A twenty ninth aspect includes the features of any of the twenty first through twenty third aspects, and wherein the instructions stored in the at least one memory include instructions executable by the at least one processor to cause the at least one processor to execute (iii) by computing a series of STFT1s with the STFT1 process stepped sequentially through the collected charge detection data, and determining from the computed series of STFT1s the oscillating frequencies of each of the multiple trapped ions and oscillation frequency standard deviations for each of the determined oscillating frequencies, and wherein the instructions stored in the at least one memory include instructions executable by the at least one processor to cause the at least one processor to execute (iv) by computing a series of STFT2s with the STFT2 process stepped sequentially through the collected charge detection data, and determining from the computed series of STFT2s the charge magnitudes of each of the multiple trapped ions, and charge magnitude standard deviations and harmonic ratios for each of the determined charge magnitudes.

A thirtieth aspect includes the features of the twenty ninth aspect, and wherein the instructions stored in the at least one memory include instructions executable by the at least one processor to cause the at least one processor to execute (v) by populating the filtered file only with associated pairs of the determined oscillating frequencies and determined charge magnitudes for which the corresponding oscillating frequency standard deviation is less than a first threshold value, the corresponding charge magnitude standard deviation is less than a second threshold value, and the corresponding harmonic ratio is within a threshold window of a target harmonic ratio value.

A thirty first aspect is directed to a particle mass analysis system which comprises the charge detection mass spectrometer of any of the twenty first through thirtieth aspects, and further comprises a charged particle generator configured to generate the ions from the sample and to supply the generated ions to the at least one ion processing stage.

### BRIEF DESCRIPTION OF THE DRAWINGS

FIG. 1 is a simplified side-view diagram of a charged detection mass spectrometer (CDMS) including an embodiment of an electrostatic linear ion trap (ELIT) with control and measurement components coupled thereto.

FIG. 2 is a simplified side-view diagram of an example embodiment of the ion source of the CDMS illustrated in FIG. 1.

FIG. 3 is a simplified diagram of an embodiment of the processor illustrated in FIG. 1.

FIGS. 4A-4C are simplified side-view diagrams of the ELIT of FIG. 1 demonstrating sequential control and operation of the ion mirrors to capture ions within the ELIT and to cause the ions to oscillate back and forth between the ion mirrors each time passing through the charge detection cylinder during which charge detection data of the ions is measured and recorded for the duration of an ion trapping event.

FIG. 5 is a flowchart illustrating an embodiment of a process for processing time-based charge detection data (CDD), resulting from simultaneous trapping of and measurement of multiple charged particles in the ELIT of the CDMS of FIG. 1, to determine charge magnitudes and frequencies of each of the trapped multiple charged ions.

FIG. 6A is a plot of fraction of ions misassigned (i.e., assigned to the wrong charge state) vs the RMSD of the measured charge.

FIG. 6B is a plot of resolution of charge states of ions with a measurement RMSD of 0.2 e.

FIGS. 7A-7F are each plots of charge versus mass for each of MSQC4, MSQC4 Aggregate, His-Switch, HBV, TRP, and pUC19, respectively.

FIG. 8A is a plot of charge RMSD vs. STFT window step size for each of four different apodization methods used to analyze a sample of MSQC4.

FIG. 8B is a plot of charge RMSD vs. STFT window step size for each of three different apodization methods used to analyze a sample of TRP.

FIG. 9A shows plots of charge RMSD and number of detected ions (counts) vs. STFT window length for each of four different apodization methods used to analyze a sample of MSQC4.

FIG. 9B shows plots of charge RMSD and number of detected ions (counts) vs. STFT window length for each of four different apodization methods used to analyze a sample of MSQC4 Aggregate.

FIG. 9C shows plots of charge RMSD and number of detected ions (counts) vs. STFT window length for each of four different apodization methods used to analyze a sample of His Switch.

FIG. 9D shows plots of charge RMSD and number of detected ions (counts) vs. STFT window length for each of four different apodization methods used to analyze a sample of HBV.

FIG. 9E shows plots of charge RMSD and number of detected ions (counts) vs. STFT window length for each of four different apodization methods used to analyze a sample of TRP.

FIG. 9F shows plots of charge RMSD and number of detected ions (counts) vs. STFT window length for each of four different apodization methods used to analyze a sample of pUC19.

FIG. 10A is a plot of measured charge distribution for MSQC4 showing baseline resolution of the charge states.

FIG. 10B is a plot of charge RMSD vs. time.

FIGS. 11A-11C are plots of charge standard deviation, m/z standard deviation, and harmonic ratio standard deviation respectively, for each of four different apodization methods used to analyze a sample of MSQC4.

FIGS. 12A-12C are plots of charge standard deviation, m/z standard deviation, and harmonic ratio standard deviation respectively, for each of four different apodization methods used to analyze a sample of MSQC4 Aggregate.

FIGS. 13A-13C are plots of charge standard deviation, m/z standard deviation, and harmonic ratio standard deviation respectively, for each of four different apodization methods used to analyze a sample of His Switch.

FIGS. 14A-14C are plots of charge standard deviation, m/z standard deviation, and harmonic ratio standard deviation respectively, for each of four different apodization methods used to analyze a sample of HBV.

FIGS. 15A-15C are plots of charge standard deviation, m/z standard deviation, and harmonic ratio standard deviation respectively, for each of four different apodization methods used to analyze a sample of TRP.

FIGS. 16A-16C are plots of charge standard deviation, m/z standard deviation, and harmonic ratio standard deviation respectively, for each of four different apodization methods used to analyze a sample of pUC19.

FIG. 17A is a plot of oscillating frequency resolving power vs. window length for each of four different apodization methods for a simulated 600e input signal.

FIG. 17B is a plot of oscillating frequency resolving power vs. window length for each of the four different apodization methods for a simulated 20e input signal.

FIG. 18A is a plot of conversion efficiency comparing the performance of Gaussian (G), rectangle (R), Blackman Harris (BH), and flat-top (FT) STFT windowing methods for analysis of CDMS data using the dual STFT approach for each of six different test samples.

FIG. 18B is a plot of charge RMSD comparing the performance of Gaussian (G), rectangle (R), Blackman Harris (BH), and flat-top (FT) STFT windowing methods for analysis of CDMS data using the dual STFT approach for each of the six different test samples.

FIG. 19 is a flowchart illustrating an example embodiment of an STFT computation and analysis process, using a dual-STFT approach, which may be used in place of the STFT computation and analysis process step of the process illustrated in FIG. 5.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

This disclosure relates to systems and methods for determining charge magnitude and oscillation frequency pairs of each of multiple charged particles with a charge detection mass spectrometer (CDMS) employing at least one electrostatic linear ion trap or orbitrap in which multiple charged particles are simultaneously trapped and measured, and in particular to such systems and methods which optimize, or perhaps maximize, the accuracies, i.e., precisions, of the charge magnitude and oscillating frequency determinations for each charged particle, to thereby provide for improved spectral distribution accuracy. For purposes of this disclosure, the phrase “charged particle detection event” is defined as detection of a charge induced on a charge detector of an electrostatic linear ion trap (ELIT) or an orbitrap by a charged particle passing a single time through or about the charge detector. In CDMS instruments in which multiple charged particles are trapped for simultaneous analysis in an ELIT or orbitrap, as is the case for the CDMS instruments disclosed herein, charged particle detection events, as just defined, occur for each of the multiple trapped charged particles. In this regard, the phrase “charged particle measurement event” is defined as a collection of charged particle detection events resulting from oscillation of the multiple charged particles back and forth through or about the charge detector a selected number of times or for a selected time period. As such back and forth oscillation of charged particles results from controlled trapping of the multiple charged particles within the ELIT or orbitrap, as will be described in detail below, the phrase “charged particle measurement event” may alternatively be referred to herein as a “charged particle trapping event” or simply as an “ion trapping event” or a “trapping event,” and the phrases “charged particle measurement event,” “charged particle trapping event”, “ion trapping event,” “trapping event” and variants thereof shall be understood to be synonymous with one another. For purposes of this disclosure, the terms “ion” and “charged particle,” and variations thereof, will be understood to be synonymous. The term “ion” may thus be substituted for the term “charged particle” in any of the above definitions.

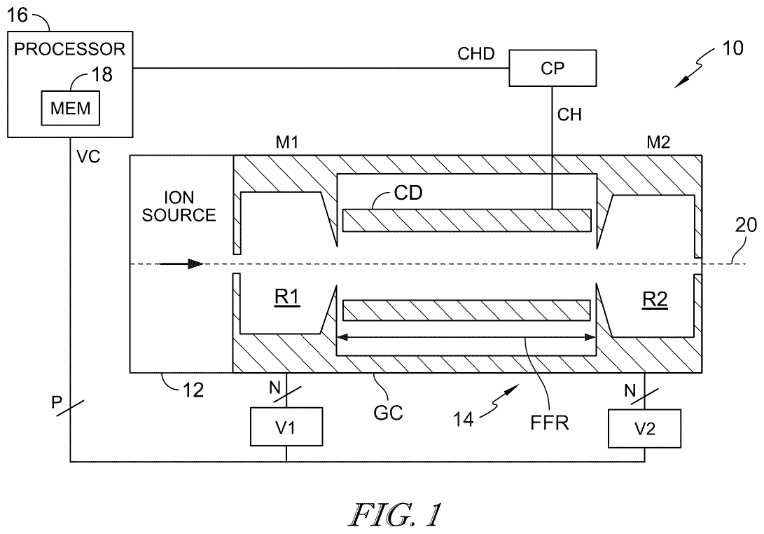

Referring to FIG. 1, an embodiment is shown of a charge detection mass spectrometer (CDMS) 10 illustratively including an electrostatic linear ion trap (ELIT) 14 as a charged particle detector, an example of which will be described below. In some alternate embodiments, a conventional orbitrap may be used as the charged particle detector in place of the ELIT 14, and one non-limiting example of such an orbitrap is disclosed in WO 2020/106310A1, the disclosure of which is expressly incorporated herein by reference in its entirety. The operation of the CDMS 10, although not limited to use of the ELIT 14, will be described in detail below using an ELIT 14 to simultaneously trap and analyze multiple charged particles.

The CDMS 10 illustrated by example in FIG. 1 further includes a charged particle source 12 operatively coupled to the ELIT 14, wherein the charged particle source 12 and the ELIT 14 together illustratively define a longitudinal axis 20 extending centrally therethrough. The charged particle source 12 illustratively includes any conventional device or apparatus for generating charged particles from a sample and may further include one or more ion processing stages in the form of one or more conventional devices and/or instruments for guiding, separating, collecting, filtering, controlling/setting energy, fragmenting and/or normalizing or shifting charge states of the generated charged particles according to one or more molecular characteristics. By example, which should not be considered to be limiting in any way, the device or apparatus for generating charged particles from a sample may be or include a conventional electrospray ionization source, a matrix-assisted laser desorption ionization (MALDI) source or the like. In some embodiments, the charged particle source 12 may further include a conventional mass spectrometer having a charged particle inlet configured to receive the generated charged particles. If included, the mass spectrometer may be of any conventional design including, for example, but not limited to a time-of-flight (TOF) mass spectrometer, an orthogonal acceleration TOF mass spectrometer, a reflectron mass spectrometer, a Fourier transform ion cyclotron resonance (FTICR) mass spectrometer, a quadrupole mass spectrometer, a triple quadrupole mass spectrometer, a magnetic sector mass spectrometer, orbitrap, or the like. In such embodiments, the charged particle source 12 may further include one or more devices and/or instruments between the device or apparatus for generating charged particles and the mass spectrometer and/or between the mass spectrometer and the ELIT 14 for guiding, separating, collecting, filtering, controlling/setting energy, fragmenting and/or normalizing or shifting charge states of the generated charged particles according to one or more molecular characteristics. In embodiments which do not include a mass spectrometer, the charged particle source 12 may include one or more devices and/or instruments between the device or apparatus for generating charged particles and the ELIT 14 for guiding, separating, collecting, filtering, controlling/setting energy, fragmenting and/or normalizing or shifting charge states of the generated charged particles according to one or more molecular characteristics. In any case, the sample from which the charged particles are generated may be or include any biological or other material or combination of materials.

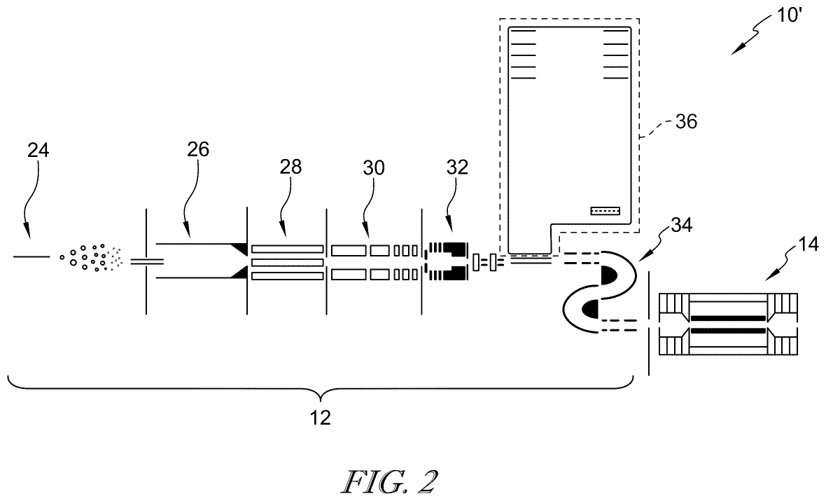

Referring now to FIG. 2, a CDMS 10′ is shown which includes an example embodiment of the ion source 12 of the CDMS 10 operatively coupled to the ELIT 14, and thus represents a non-limiting example embodiment of the CDMS 10 illustrated in FIG. 1. In the example embodiment illustrated in FIG. 2, the ion source 12 illustratively includes a conventional electrospray ionization source 24 having a charged particle outlet positioned to supply charged particles to a charged particle inlet of a conventional charged particle interface 26 configured to guide charged particles from a region of high pressure, e.g., atmospheric pressure, in which the ionization source 24 resides to a region of lower pressure, e.g., a vacuum condition, of a downstream stage 28 of the ion source 12. Non-limiting examples of such a charged particle interface 26, in which a supersonic jet of electrosprayed ions entering the CDMS 10′ is broken up and the ions are thermalized, are disclosed in WO 2019/236139A1 and WO 2019/236572A1, the disclosures of which are both expressly incorporated herein by reference in their entireties.

In the embodiment depicted in FIG. 2, the stage 28 of the ion source 12 is illustratively implemented in the form of a conventional RF-only hexapole. The RF-only hexapole 28 has a charged particle inlet operatively coupled to a charged particle outlet of the charged particle interface 26, and a charged particle outlet operatively coupled to a charged particle inlet of a downstream stage 30. Operation of the RF-only hexapole 28 is conventional and acts to guide charged particles axially through hexapole 28 from the charged particle inlet to charged particle outlet thereof while also radially focusing and confining the charged particle to and about the longitudinal axis 20 defined centrally through the ion source 12 (see FIG. 1). In the illustrated embodiment, the DC potential on the hexapole 28 sets the nominal energy of the ions, e.g., 130 eV/z (although other nominal ion energies may alternatively be used).

Stage 30 of the ion source 12 of FIG. 2 is illustratively implemented in the form of a conventional RF-only quadrupole. The RF-only quadrupole 30 has a charged particle inlet operatively coupled to a charged particle outlet of the hexapole 28, and a charged particle outlet operatively coupled to a charged particle inlet of a downstream stage 32. Operation of the RF-only quadrupole 30 is conventional and acts to guide charged particles axially through quadrupole 30 from the charged particle inlet to charged particle outlet thereof while also radially focusing and confining the charged particle about the longitudinal axis 20 defined centrally through the ion source 12 (see FIG. 1). In some, but not necessarily all, embodiments, the RF-only quadrupole 30 may be controlled as described in co-pending International Application No. PCT/US2023/073710, the disclosure of which is expressly incorporated herein by reference in its entirety, to eliminate, or at least reduce, the effects of “noding” associated with otherwise conventional operation of an RF-only quadrupole, wherein the term “noding” refers, in the context of FIG. 2, to off-axis exit of charged particles from the charged particle outlet of the RF-only quadrupole 30, resulting in angular deviation from the central, longitudinal axis 20 of at least some of the charged particles exiting the charged particle outlet of the quadrupole 30 and as the charged particles move away from the charged particle outlet of the quadrupole 30.

The stage 32 of the ion source 12 of FIG. 2 is illustratively implemented in the form of conventional charged particle focusing optics. Charged particles passing through the optics 32 are focused into a charged particle inlet of a conventional dual-hemisphere energy analyzer 34 having a charged particle outlet operatively coupled to, or otherwise aligned with, a charged particle inlet of the ELIT 14. The energy analyzer 34 illustratively operates to transmit to the ELIT 14 only charged particles having ion energies in a narrow band of kinetic energies centered on the nominal ion energy. In one embodiment in which the ELIT 14 is provided in the form described by example below, the energy analyzer 34 is configured to transmit only charged particles having ion energies in a narrow band of energies centered around the nominal ion energy of approximately 130 eV/z, although it will be understood that in other embodiments the energy analyzer 34 may be configured to transmit charged particles centered around a band or window of energies of any desired size and/or centered around other charged particle energy values, i.e., other than 130 eV/z.

In the embodiment illustrated in FIG. 2, multiple charged particles are fed from the focusing optics 32 directly into the ELIT 14 via the energy analyzer 34. In some alternate embodiments, a mass spectrometer 36 may be interposed between the focusing optics 32 and the energy analyzer 34 to provide for separation of charged particles as a function of mass-to-charge ratio, m/z, prior to entrance into the ELIT 14, as depicted by dashed-line representation in FIG. 2. In one example embodiment, the mass spectrometer 36 may be a conventional orthogonal acceleration TOF mass spectrometer, although in other embodiments which include it, the mass spectrometer 36 may take other conventional forms, some examples of which are described above with respect to FIG. 1.

Referring again to FIG. 1, the ELIT 14 depicted by example illustratively includes a charge detector CD, surrounded by a ground chamber or cylinder GC, and operatively coupled to opposing ion mirrors M1, M2 respectively positioned at opposite ends of the charged detector CD. The ion mirrors M1, M2 may alternatively be referred to herein as “endcaps” or “end caps,” it being understood that the terms ion mirror and endcap (or end cap) are, for purposes of this disclosure, synonymous. The ion mirror M1 is operatively positioned between the charged particle outlet of the charged particle source 12 and one end of the charge detector CD, and the ion mirror M2 is operatively positioned at the opposite end of the charge detector CD. Each ion mirror M1, M2 defines a respective ion mirror region R1, R2 therein. The regions R1, R2 of the ion mirrors M1, M2, the charge detector CD, and the spaces between the charge detector CD and the ion mirrors M1, M2 are axially aligned such that together they define the longitudinal axis 20 centrally therethrough which illustratively represents an ideal ion travel path through the ELIT 14 and between the ion mirrors M1, M2 as will be described in greater detail below. The region defined axially between the opposed inner surfaces of the ion mirrors M1, M2, i.e., in which the charge detector CD is positioned, illustratively defines a field-free region FFR, i.e., in which no electric field is established during the operation of the ELIT 14.

In the illustrated embodiment, voltage sources V1, V2 are electrically coupled to the ion mirrors M1, M2, respectively. Each voltage source V1, V2 illustratively includes one or more switchable DC voltage sources which may be controlled or programmed to selectively produce a number, N, programmable or controllable voltages, wherein N may be any positive integer. Such voltages may illustratively be programmed to establish each of two different operating modes of each of the ion mirrors M1, M2 as will be described in detail below. In any case, the ELIT 14 is designed such that charged particles move within the ELIT 14 close to the longitudinal axis 20 under the influence of electric fields selectively established in the ion mirrors M1, M2 by the voltage sources V1, V2.

The voltage sources V1, V2 are illustratively shown electrically connected by a number, P, of signal paths to a conventional processor 16 including a memory 18 having instructions stored therein which, when executed by the processor 16, cause the processor 16 to control the voltage sources V1, V2 to produce desired DC output voltages for selectively establishing ion transmission and ion reflection electric fields, T, R respectively, within the regions R1, R2 of the respective ion mirrors M1, M2 (see, e.g., FIGS. 4A-4C). P may be any positive integer. In some alternate embodiments, either or both of the voltage sources V1, V2 may alternatively or additionally be programmable to selectively produce one or more constant output voltages. In other alternative embodiments, either or both of the voltage sources V1, V2 may be configured to produce one or more time-varying output voltages of any desired shape. It will be understood that more or fewer voltage sources may be electrically connected to the mirrors M1, M2 in alternate embodiments. In any case, the ion mirrors M1, M2 are, in some embodiments, constructed with a number of axially spaced-apart electrically conductive electrodes or rings.

Voltage outputs of the voltage source V1 are electrically connected to respective ones of the electrically conductive electrodes of the ion mirror M1, and voltage outputs of the voltage source V2 are electrically connected to respective ones of the electrically conductive electrodes of the ion mirror M2, and the various voltage outputs of the voltage sources V1, V2 are controlled in a conventional manner to selectively establish the ion transmission and ion reflection electric fields (T, R) within the respective regions R1, R2 of the ion mirrors M1, M2. Each ion mirror M1, M2 is illustratively controllable and switchable, by selective application of the voltages produced by the voltage sources V1, V2, between the ion transmission mode, in which the voltages produced by the respective voltage source V1, V2 establish the ion transmission electric field (T) in the respective region R1, R2 thereof, and an ion reflection mode in which the voltages produced by the respect voltage source V1, V2 establish the ion reflection electric field (R) in the respective region R1, R2 thereof.

The charge detector CD is illustratively provided in the form of an electrically conductive cylinder, illustratively referred to herein as a charge detection cylinder, which is electrically connected to a signal input of a charge sensitive preamplifier CP, and the signal output of the charge-sensitive preamplifier CP is electrically coupled to the processor 16. In embodiments in which the charged particle detector is implemented in the form of an orbitrap, as described above, the charge detector CD may illustratively be provided in the form of an electrically conductive spindle assembly about which ions oscillate in a conventional manner. In any case, referring again to FIG. 1, the voltage sources V1, V2 are illustratively controlled in a manner, which selectively traps in the ELIT 14 multiple charged particles entering the charged particle inlet of the ELIT 14 and causes each of the multiple trapped charged particles to oscillate with the ELIT 14 back and forth between the ion mirrors M1, M2 each time passing axially through the charge detection cylinder CD. An ion transmission electric field, T, established in an ion mirror M1, M2, for example, illustratively operates to focus charged particles toward the longitudinal axis 20 of the ELIT 14 as the charged particles pass through the ion mirror M1, M2. An ion reflection electric field, R, established in an ion mirror M1, M2, in contrast, illustratively acts to decelerate and stop charged particles entering the ion mirror M1, M2 from the charge detection cylinder CD, and to then accelerate the stopped charged particle in the opposite direction back into the respective end of the charge detection cylinder CD, and to focus the charged particles toward the central, longitudinal axis 20. By selectively establishing the ion transmission and ion reflection electric fields (T, R respectively) in the ion mirrors M1, M2, multiple ions can be trapped in the ELIT 14 and made to oscillate back and forth between the ion mirrors M1, M2, each time passing through the charge detection cylinder CD and inducing respective charges on the charge detection cylinder CD which are detected by the charge sensitive preamplifier CP. Thus, with multiple charged particles trapped within the ELIT 14 and oscillating back and forth between the ion mirrors M1, M2, the charge sensitive preamplifier CP is illustratively operable in a conventional manner to detect charges (CH) respectively induced on the charge detection cylinder CD as each of the multiple charged particles repeatedly pass through the charge detection cylinder CD between the ion mirrors M1, M2, and to produce charge detection signals (CHD) corresponding thereto. Further details relating to the structure and operation of an example embodiment of the ion mirrors M1, M2, and of the ELIT 14 generally, are disclosed in WO 2019/140233, the disclosure of which is expressly incorporated herein in its entirety. In the following discussion and example(s) provided below, the ELIT 14 is illustratively designed, as described in WO 2019/140233, to have a 50% duty cycle so that even harmonics of the frequency-domain ion measurement data vanish, thus leaving only the fundamental and odd harmonics in the frequency domain data, although it will be understood that in other embodiments other ELIT designs may instead be used.

The charge detection signals CHD are illustratively periodic and are recorded in the form of amplitude and period values and, in this regard, each amplitude and period pair represents ion measurement information for a charge detection event in which a respective one of the multiple charged particles is traveling through the charge detection cylinder CD. The amplitude is the amplitude of the charge induced by the charged particle on the charge detection cylinder as the charged particle passes therethrough, and the period value is the time duration of passage of the charged particle through the charge detection cylinder. A plurality of such amplitude and period values are measured and recorded during a respective charged particle measurement event (i.e., during a charged particle trapping event), and the resulting plurality of recorded values i.e., the collection of recorded charged particle measurement information, for the charged particle measurement event, is processed to determine mass-to-charge ratios (m/z) and charge magnitudes of each of the multiple charged particles, as will be described below. Charged particle mass values are then computed based on the m/z and corresponding charge magnitude values. Multiple charged particle measurement events can be processed in this manner, and a mass-to-charge ratio and/or mass and/or charge spectrum of the sample may illustratively be constructed therefrom in a conventional manner.

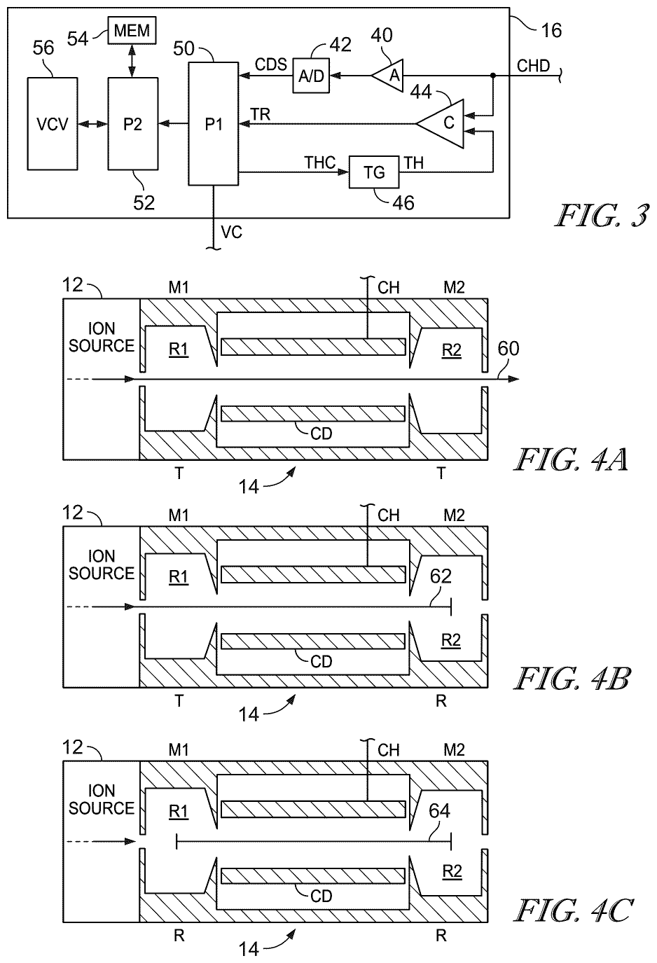

Referring now to FIG. 3, an embodiment is shown of the processor 16 illustrated in FIG. 1. In the illustrated embodiment, the processor 16 includes a conventional amplifier circuit 40 having an input receiving the charge detection signal CHD produced by the charge sensitive preamplifier CP and an output electrically connected to an input of a conventional Analog-to-Digital (A/D) converter 42. An output of the A/D converter 42 is electrically connected to a processor 50 (P1). The amplifier 40 is operable in a conventional manner to amplify the charge detection signal CHD produced by the charge sensitive preamplifier CP, and the A/D converter 42 is, in turn, operable in a conventional manner to convert the amplified charge detection signal to a digital charge detection signal CDS.

The processor 16 illustrated in FIG. 3 further illustratively includes a conventional comparator 44 having a first input receiving the charge detection signal CHD produced by the charge sensitive preamplifier CP, a second input receiving a threshold voltage CTH produced by a threshold voltage generator (TG) 46 and an output electrically connected to the processor 50. The comparator 44 is operable in a conventional manner to produce a trigger signal TR at the output thereof which is dependent upon the magnitude of the charge detection signal CDH relative to the magnitude of the threshold voltage CTH. In one embodiment, for example, the comparator 44 is operable to produce an “inactive” trigger signal TR at or near a reference voltage, e.g., ground potential, as long as CHD is less than CTH, and is operable to produce an “active” TR signal at or near a supply voltage of the circuitry 40, 42, 44, 46, 50 or otherwise distinguishable from the inactive TR signal when CHD is at or exceeds CTH. In alternate embodiments, the comparator 44 may be operable to produce an “inactive” trigger signal TR at or near the supply voltage as long as CHD is less than CTH, and is operable to produce an “active” trigger signal TR at or near the reference potential when CHD is at or exceeds CTH. Those skilled in the art will recognize other differing trigger signal magnitudes and/or differing trigger signal polarities that may be used to establish the “inactive” and “active” states of the trigger signal TR so long as such differing trigger signal magnitudes and/or different trigger signal polarities are distinguishable by the processor 50, and it will be understood that any such other different trigger signal magnitudes and/or differing trigger signal polarities are intended to fall within the scope of this disclosure. In any case, the comparator 44 may additionally be designed in a conventional manner to include a desired amount of hysteresis to prevent rapid switching of the output between the reference and supply voltages.

The processor 50 is illustratively operable to produce a threshold voltage control signal THC and to supply THC to the threshold generator 46 to control operation thereof. In some embodiments, the processor 50 is programmed or programmable to control production of the threshold voltage control signal THC in a manner which controls the threshold voltage generator 46 to produce CTH with a desired magnitude and/or polarity. In other embodiments, a user may provide the processor 50 with instructions in real time, e.g., through a downstream processor, e.g., via a virtual control and visualization unit 56, to control production of the threshold voltage control signal THC in a manner which controls the threshold voltage generator 46 to produce CTH with a desired magnitude and/or polarity. In either case, the threshold voltage generator 46 is illustratively implemented, in some embodiments, in the form of a conventional controllable DC voltage source configured to be responsive to a digital form of the threshold control signal THC, e.g., in the form of a single serial digital signal or multiple parallel digital signals, to produce an analog threshold voltage CTH having a polarity and a magnitude defined by the digital threshold control signal THC. In some alternate embodiments, the threshold voltage generator 46 may be provided in the form of a conventional digital-to-analog (D/A) converter responsive to a serial or parallel digital threshold voltage TCH to produce an analog threshold voltage CTH having a magnitude, and in some embodiments a polarity, defined by the digital threshold control signals THC. In some such embodiments, the D/A converter may form part of the processor 50. Those skilled in the art will recognize other conventional circuits and techniques for selectively producing the threshold voltage CTH of desired magnitude and/or polarity in response to one or more digital and/or analog forms of the control signal THC, and it will be understood that any such other conventional circuits and/or techniques are intended to fall within the scope of this disclosure.

In addition to the foregoing functions performed by the processor 50, the processor 50 is further operable to control the voltage sources V1, V2 as described above with respect to FIG. 1 to selectively establish ion transmission and reflection fields (T, R respectively) within the regions R1, R2 of the ion mirrors M1, M2, respectively. In some embodiments, the processor 50 is programmed or programmable to control the voltage sources V1, V2. In other embodiments, the voltage source(s) V1 and/or V2 may be programmed or otherwise controlled in real time by a user, e.g., through a downstream processor 52, e.g., via a virtual control and visualization unit. In either case, the processor 50 is, in one embodiment, illustratively provided in the form of a field programmable gate array (FPGA) programmed or otherwise instructed by a user to collect and store charge detection signals CDS for charge detection events and for ion measurement events, to produce the threshold control signal(s) TCH from which the magnitude and/or polarity of the threshold voltage CTH is determined or derived, and to control the voltage sources V1, V2. In this embodiment, the memory 18 described with respect to FIG. 1 is integrated into, and forms part of, the programming of the FPGA. In alternate embodiments, the processor 50 may be provided in the form of one or more conventional microprocessors or controllers and one or more accompanying memory units having instructions stored therein which, when executed by the one or more microprocessors or controllers, cause the one or more microprocessors or controllers to operate as just described. In other alternate embodiments, the processing circuit 50 may be implemented purely in the form of one or more conventional hardware circuits designed to operate as described above, or as a combination of one or more such hardware circuits and at least one microprocessor or controller operable to execute instructions stored in memory to operate as described above.

The embodiment of the processor 16 depicted by example in FIG. 3 further illustratively includes a second processor 52 operatively coupled to the first processor 50 and also to at least one memory unit 54. In some embodiments, the processor 52 may include one or more peripheral devices, such as a display monitor, one or more input and/or output devices or the like, although in other embodiments the processor 52 may not include any such peripheral devices. In any case, the processor 52 is illustratively configured, i.e., programmed, to execute at least one process for analyzing ion measurement events. Time-based charge detection data (CDD) in the form of charge magnitude and charge timing data (i.e., detection of the timing of charges induced by ions on the charge detection cylinder) received by the processor 50 via the charge detection signals CDS is illustratively transferred from the processor 50 directly to the processor 52 for processing and analysis upon completion of each ion measurement event.

In some embodiments, the processor 52 is illustratively provided in the form of a high-speed server operable to perform both collection/storage and analysis of such data. In such embodiments, one or more high-speed memory units 54 may be coupled to the processor 52, and is/are operable to store data received and analyzed by the processor 52. In one embodiment, the one or more memory units 54 illustratively include at least one local memory unit for storing data being used or to be used by the processor 52, and at least one permanent storage memory unit for storing data long term. In one such embodiment, the processor 52 is illustratively provided in the form of a Linux® server (e.g., OpenSuse Leap 42.1) with four Intel® Xeon™ processors (e.g., E5-465L v2, 12 core, 2.4 GHz). In this embodiment, an improvement in the average analysis time of a single ion measurement event file of over 100× is realized as compared with a conventional Windows® PC (e.g., i5-2500K, 4 cores, 3.3 GHz). Likewise, the processor 52 of this embodiment together with high speed/high performance memory unit(s) 54 illustratively provide for an improvement of over 100× in data storage speed. Those skilled in the art will recognize one or more other high-speed data processing and analysis systems that may be implemented as the processor 52, and it will be understood that any such one or more other high-speed data processing and analysis systems are intended to fall within the scope of this disclosure. In alternate embodiments, the processor 52 may be provided in the form of one or more conventional microprocessors or controllers and one or more accompanying memory units having instructions stored therein which, when executed by the one or more microprocessors or controllers, cause the one or more microprocessors or controllers to operate as described herein.

In the illustrated embodiment, the memory unit 54 illustratively has instructions stored therein which are executable by the processor 52 to analyze ion measurement event data produced by the ELIT 14 to determine an ion spectral distribution, i.e., ion mass-to-charge ratio (m/z), ion charge magnitude, ion mass, etc., for a sample under analysis. In one embodiment, the processor 52 is operable to receive ion measurement event data from the processor 50 in the form of charge magnitude and charge detection timing information measured during each of multiple “charge detection events” (as this term is defined above) making up the “ion measurement event” (as this term is defined above), and to process such charge detection events making up such an ion measurement event to determine ion charge and mass-to-charge data, and to then determine ion mass data therefrom. A mass spectral distribution for the sample under analysis can be created in this manner from an ion measurement event in which multiple charged particles are trapped in the ELIT 14 as described above. Multiple ion measurement events may also be processed in like manner to create a mass spectral distribution for the sample under analysis.

In some embodiments, the CDMS 10 described above may be managed in real-time directly from and by the processor 52, wherein operating parameters of the CDMS system 10 and of the ELIT 14 in particular may be selected, e.g., in real time or at any time, and output file management and display may be managed. In other embodiments, the processor 16 may include a separate processor 56 coupled to the processor 52 as illustrated by example in FIG. 3. In such embodiments, the processor 56 is illustratively a conventional processor or processing system for which widely known and used graphing utilities and data processing programs are available. In one example embodiment, the processor 56 is implemented in the form of a conventional Windows®-based personal computer (PC) including one or more such graphing utilities and data processing programs installed thereon. Those skilled in the art will recognize other conventional processors or processing systems which may be suitable for used as the processor 56, and it will be understood that any such other conventional processors or processing systems are intended to fall within the scope of this disclosure. In any case, in embodiments which include the processor 56, a graphical user interface (GUI), e.g., an RTA GUI, may be included to provide a user-friendly and real-time control GUI which is accessible via the processor 56. In one embodiment, the real-time control GUI is stored in the memory 54 and executed by the processor 52, and the processor 56 is used to access the user GUI from the processor 52, e.g., via a secure shell connection between the two processors 52, 56. In alternate embodiments, the real-time control GUI may be stored on and executed by the processor 56. In either case, the processor 56 illustratively acts as a virtual control and visualization unit with which a user may visualize and control one or more aspects of the real time analysis process and of the real-time operation of the CDMS 10 via the real-time control GUI. Whether used to control real-time operation of the CDMS or not, the processor 56 may illustratively be used to visualize output data and spectral distribution information produced by the CDMS instrument 10.

As briefly described above, the voltage sources V1, V2 are illustratively controlled by the processor 16, e.g., via the processor 50, in a manner which selectively establishes ion transmission and ion reflection electric fields (T, R respectively) in the region R1 of the ion mirror M1 and in the region R2 of the ion mirror M2 to guide charged particles into the ELIT 14 from the charged particle source 12, and to then cause multiple charged particles to be selectively trapped and confined within the ELIT 14 such that the multiple trapped charged particles repeatedly pass through the charge detection cylinder CD as they oscillates back and forth between M1 and M2. Referring to FIGS. 4A-4C, simplified diagrams of the ELIT 14 of FIG. 1 are shown depicting an example of such sequential control and operation of the ion mirrors M1, M2 of the ELIT 14. In the following example, the processor 50 will be described as controlling the operation of the voltage sources V1, V2 in accordance with its programming, although it will be understood that the operation of the voltage source V1 and/or the operation of the voltage source V2 may be alternatively controlled, at least in part, by the processor 52.

As illustrated in FIG. 4A, the ELIT control sequence begins with the processor 50 controlling the voltage source V1 to control the ion mirror M1 to the ion transmission mode of operation (T) by establishing an ion transmission field within the region R1 of the ion mirror M1, and also controlling the voltage source V2 to control the ion mirror M2 to the ion transmission mode of operation (T) by likewise establishing an ion transmission field within the region R2 of the ion mirror M2. As a result, charged particles generated by the charged particle source 12 pass into the ion mirror M1 and are focused by the ion transmission field established in the region R1 toward the central, longitudinal axis 20 (see FIG. 1) as they pass into the charge detection cylinder CD. The charged particles then pass through the charge detection cylinder CD and into the ion mirror M2 where the ion transmission field established within the region R2 of M2 focusses the charged particles toward the longitudinal axis 20 such that the charged particles pass through M2 as illustrated by the ion trajectory 60 depicted in FIG. 4A.

Referring now to FIG. 4B, after both of the ion mirrors M1, M2 have been operating in the ion transmission operating mode for a selected time period and/or until successful ion transmission therethrough has been achieved (e.g., by monitoring the charge detection signal CDS to determine the presence of charged particles passing through the charge detection cylinder CD), the processor 50 is illustratively operable to control the voltage source V2 to control the ion mirror M2 to the ion reflection mode (R) of operation by establishing an ion reflection field within the region R2 of the ion mirror M2, while maintaining the ion mirror M1 in the ion transmission mode (T) of operation as shown. As a result, charged particles generated by the charged particle source 12 enter into the ion mirror M1 and are focused by the ion transmission field T established in the region R1 toward the central, longitudinal axis 20 such that the charged particles pass through the ion mirror M1 and into the charge detection cylinder CD as just described with respect to FIG. 4A. The charged particles then pass through the charge detection cylinder CD and into the ion mirror M2 where the ion reflection field R established within the region R2 of M2 reflects the charged particles to cause them to reverse travel so as to travel in the opposite direction and back into the charge detection cylinder CD, as illustrated by the ion trajectory 62 in FIG. 4B.

Referring now to FIG. 4C, after the ion reflection electric field has been established in the region R2 of the ion mirror M2, the processor 50 is operable to control the voltage source V1 to control the ion mirror M1 to the ion reflection mode (R) of operation by establishing an ion reflection field within the region R1 of the ion mirror M1, while maintaining the ion mirror M2 in the ion reflection mode (R) of operation in order to trap the multiple charged particles within the ELIT 14. Between the time that the ion reflection electric field (R) is established within the region R1 of the ion mirror M1 and the ion reflection electric field (R) is established within the region R1 of the ion mirror M2, multiple charged particles enter, and are trapped within, the ELIT 14. With both of the ion mirrors M1, M2 controlled to the ion reflection operating mode (R), the multiple trapped charged particles are caused by the opposing ion reflection fields established in the regions R1 and R2 of the ion mirrors M1 and M2 respectively to oscillate back and forth between the ion mirrors M1 and M2, each time passing through the charge detection cylinder CD as illustrated by the ion trajectory 64 depicted in FIG. 4C and as described above. In one embodiment, the processor 50 is operable to maintain the operating state illustrated in FIG. 4C until the multiple trapped charged particles pass through the charge detection cylinder CD a selected number of times. In an alternate embodiment, the processor 50 is operable to maintain the operating state illustrated in FIG. 4C for a selected time period after trapping the multiple ions in the ELIT 14.

In either embodiment, the number of cycles or time spent in the state illustrated in FIG. 4C may illustratively be programmed, e.g., via instructions stored in the memory 18, or controlled via a user interface, and in any case the ion detection event information resulting from each pass by each of the multiple trapped ions through the charge detection cylinder CD, i.e., in the form of time-based charge detection data (CDD) as described above, is temporarily stored in the processor 50, e.g., in the form of an ion measurement file. When the multiple trapped charged particles have passed through the charge detection cylinder CD a selected number of times or have oscillated back-and-forth between the ion mirrors M1, M2 for a selected period of time, the total number of charged particle detection events stored in the processor 50 represents the charged detection data (CDD), as described above, for a charged particle measurement event (i.e., for an “ion trapping event”) for the multiple trapped charged particles and, upon completion of the charged particle measurement event, the charged particle detection data (CDD) for the charged particle measurement event is stored in a charge detection file (CDF) which is then passed to, or retrieved by, the processor 52. The sequence illustrated in FIGS. 4A-4C then returns to that illustrated in FIG. 4A where the voltage sources V1, V2 are controlled as described above to control the ion mirrors M1, M2 respectively to the ion transmission mode (T) of operation by establishing ion transmission fields within the regions R1, R2 of the ion mirrors M1, M2 respectively. The illustrated sequence then repeats for as many times as desired.

The time-based charge detection data (CDD) in a charge detection file (CDF) is illustratively analyzed in the frequency domain using Fast Fourier Transform (FFT) processes. In such implementations, oscillation frequency and charge magnitude pairs are determined for each of the multiple charged particles trapped in the ELIT 14 based on the fundamental frequencies (f0) of the FFTs, wherein the oscillation frequency and charge magnitude of each of the multiple charged particles corresponds to the frequency and magnitude respectively of the fundamental frequency f0 of that charged particle. Ultimately, i.e., following processing of the CDD for one or multiple ion trapping events, mass-to-charge ratios (m/z) of the charged particles are determined based on the fundamental frequency f0 and a calibration constant (C) according to Equation 1 below, and the masses of the charged particles are then determined as products of the respective m/z and charge magnitude of each of the charged particles.

$$\frac{m}{z} = \frac{C}{{f}_{0}^{2}} \qquad Equation 1$$

Referring now to FIG. 5, a flowchart is shown of a process 100 for processing the time-based charge detection data (CDD) resulting from measurements by the charge-sensitive preamplifier, CP, of charges induced on the charge detection cylinder, CD, by the multiple trapped charged particles passing therethrough as they oscillate back and forth between the ion mirrors M1, M2 during one or more trapping events as described above, and for ultimately determining mass-to-charge ratios and charge magnitudes of such charged particles. Resulting from one or more iterations of the process 100 is a charged particle spectral distribution, including one or a combination of mass-to-charge ratio (m/z), mass (m), and charge magnitude (z), for each of the multiple trapped charged particles of the one or more trapping events. The process 100 is illustratively stored and executed in and by the processor 50 described above, stored in the memory 54 and executed by the processor 52, stored and executed in and by the processor 56, stored, in part, in the processor 50 and, in part, in the memory 54, and executed, in part, by the processor 50 and, in part, by the processor 52, or stored, in part, in the processor 56 and, in part, in the memory 54, and executed, in part, by the processor 56 and, in part, by the processor 52. In this regard, the phrase “50, 52 and/or 56” means one or any sub-combination or combination of the processors 50, 52, 56. In any case, the process 100 begins at step 102 where the time-based charge detection data (CDD) for an ion trapping event (ITE) (alternatively, an “ion measurement event” as described above) is collected and stored in a charge detection file (CDF), as described above in the example depicted in FIGS. 4A-4C. In one embodiment, charge detection data, CDD, for a first time window of the ITE is discarded, and CDD for a remaining time duration is collected and stored in the CDF. In one non-limiting example of such an embodiment, CDD for the first 2-4 milliseconds (ms) of the ITE is discarded to avoid transients from which of the ion mirror potentials in the ELIT 14. In alternate embodiments more or less (or none) of the initial or front-end CDD may be discarded, and the ITE may last for any desired duration so as to collect any number of data points over the ITE duration.

Following step 102, the process 100 advances to step 104 where the processor 50, 52 and/or 56 is operable to compute a “full event” Fourier transform (FEFT) of all the charge detection data in the CDF. In one embodiment, the processor 50, 52 and/or 56 is operable to compute FEFT using a conventional fast Fourier transform (FFT) technique, although in alternate embodiments the processor 50, 52 and/or 56 may alternative or additionally use any conventional Fourier transform technique. The full event FEFT is illustratively used to identify all ion signals that exceed a preset noise threshold. The signal from each oscillating ion is illustratively a rounded square wave, and with the embodiment of the ELIT 14 designed with a 50% duty cycle as described above, the FEFT consists of the fundamental and odd harmonics. The intensities of the harmonics depend on the duty cycle, and the 50% duty cycle, i.e., the fraction of an oscillation period spent in the charge detection cylinder CD of the example ELIT 14, thus ensures that the intensities of the resultingly well separated harmonics of the FEFT are well defined. Following step 104, the processor 50, 52 and/or 56 is operable at step 106 to determine whether, based on the FEFT, no ions were captured in the ELIT 14 during the ITE, i.e., whether the ion trapping event failed to trap any charged particles in the ELIT 14. For example, if the FEFT at step 104 failed to produce any frequency peaks, captured only noise peaks, or the like, such that no valid oscillating frequency and charge magnitude pairs could be determined from the FEFT, the processor 50, 52 and/or 56 makes the determination no charged particles were trapped in the ELIT 14 during the ion trapping event (ITE). If so, the process advances to step 108 where the processor 50, 52 and/or 56 is operable to discard the charge detection data (CDD) in the charge detection file (CDF), and the process 100 loops back to step 102. In some alternate embodiments, step 108 may execute a process in which the processor 50, 52 and/or 56 is operable to analyze the CDD in the CDF and/or the FEFT (before discarding the CDD) in further detail to determine whether the charge detection data (CDD) does in fact include some discernible charged particle measurement information. If, resulting from such analysis, the CDD does include discernible charged particle measurement information, the corresponding FEFT is passed to step 110 for further processing as indicated by the dashed-lined arrow extending between steps 108 and 110, and otherwise the process 100 loops back to step 102 as described above. A non-limiting example of such a further detailed process for analyzing the CDD in the CDF and/or the FEFT at step 108 is disclosed in WO 2019/236140, the disclosure of which is expressly incorporated herein in its entirety. In any case, following step 108 or following the “NO” branch of step 106, the processor 50, 52 and/or 56 is operable at step 110 to analyze the FEFT to determine and identify in a conventional manner, e.g., from the frequency peaks in the FEFT, each of the multiple ions trapped (and measured) in the ELIT 14 during the ITE.

Following step 110, the process 100 advances to step 112 where the processor 50, 52 and/or 56 is operable to execute a short-time overlapping Fourier Transform (STFT) computation and analysis process to determine, from the charge detection data (CDD), charge magnitudes and oscillating frequencies of each of the charged particles identified from the FEFT at step 110. Generally, and as will be described in greater detail below, step 112 illustratively includes a step 114 in which the processor 50, 52, and/or 56 is operable to compute short-time overlapping Fourier transforms (STFT), e.g., using an FFT or other conventional Fourier transform determination technique, stepped sequentially through the charge detection data (CDD) in the charge detection file (CDF), i.e., stepped sequentially through CDD as a function of time.

The ions identified in the FEFT are tracked as the STFTs are stepped through the charge detection data, and the oscillating frequencies, as well as the magnitudes of the fundamental and third harmonics, are recorded for each. The number and step-size (i.e., width) of the STFTs may vary, and may depend on one or more factors, some examples of which will be described in detail below. In some embodiments, the STFTs are zero-padded to produce files sizes equivalent to that of the CDD and FEFT. In any case, the processor 50, 52, and/or 56 is operable at step 114 to process the multiple STFTs to determine from the recorded data oscillating frequency (OFR) and charge magnitude (CM) pairs for each ion identified in the FEFT. For example, for each of the multiple, trapped charged particles, at least some of the STFTs across the ITE will include a frequency peak at the fundamental frequency f0 of that charged particle within the ELIT 14. For each such multiple, trapped charged particle, the processor 50, 52 and/or 56 is illustratively operable at step 114 to determine the oscillating frequency (OFR) of the charged particle as an average of the fundamental frequencies f0 of that charged particle over all of the STFTs which include f0 of that charged particle, and to determine the charge magnitude (CM) as an average of the peak magnitudes of all such fundamental frequencies f0. In some embodiments, the processor 50, 52, and/or 56 is further operable at step 114 to also compute an average harmonic ratio (HR) for each identified ion as an average over the STFTs of a ratio of the magnitude of the fundamental frequency and the magnitude of the third harmonic frequency recorded for that ion in each STFT.

Step 112 further includes step 116 in which the processor 50, 52, and/or 56 is operable to conduct a quality check of the OFR and CM pairs determined at step 114, and to store acceptable OFR and CM pairs in a filtered file (FF). As part of the quality check, the processor 50, 52 and/or 56 is further illustratively operable at step 114 (or at step 116) to compute, for each of the multiple, charged particles, a standard deviation of the oscillating frequency (SDOF) and a standard deviation of the charge magnitude (SDC) relative to all of the fundamental frequency and peak magnitude values used to compute the respective OFR and CM averages. Thus, for every OFR, CM and HR pair, there will also be an associated oscillating frequency standard deviation (SDOF) and an associated charge magnitude standard deviation (SDC). In one example implementation of the quality check conducted at step 116, the processor 50, 52 and/or 56 is operable to store OFR and CM pairs in the filtered file FF if: (1) the ion was not lost before the end of the ion trapping event, (2) the associated SDC is less than a threshold standard deviation value TH1, (2) the associated SDOF (is less than another threshold standard deviation value TH2, and (4) the associated HR is within a window (i.e., between upper and lower limits) of a target HR magnitude.

Filtering condition (1) is illustratively conducted for each of the charged particles identified at step 110 by tracking the respective charged particle across the series of short-time overlapping FFT's, and determining whether frequency data for that charged particle is present for the full ITE. In one embodiment, a “full” trapping event is illustratively defined as one in which a charged particle is trapped within the ELIT 14 for at least a set amount of the total trapping time of the trapping event ITE, e.g., for at least 90% of the total trapping time of the trapping event ITE. In other embodiments, the set amount of time may be greater or less than %90 of the ITE, and in still other embodiments the set amount of time may be %100 of the ITE; i.e., a “full” trapping event corresponds to the entire ITE. Illustratively, the filtering condition (1) analysis may be carried out by the processor 50, 52 and/or 56 at step 152 by analyzing the STFT data as just described for the selected OFR and CM pair.

With respect to filtering condition (2), trapped charged particles having similar oscillation frequencies may have overlapping f0 values in the frequency domain, and the amount or degree of frequency overlap will affect the charge magnitude standard deviation values SDC. Because the charge magnitude of an individual charged particle in the set of trapped charged particles is determined in the frequency domain as the average magnitude of the peak of the corresponding fundamental frequency values f0 of the series of STFTs, such charge magnitude determinations become less reliable as the overlap between oscillation frequencies of trapped charged particles increases due to frequency peak crowding. And the greater the amount or degree of frequency overlap, for example, the greater will be the value of the corresponding SDC. In this regard, charged particles having a charge magnitude standard deviation SDC that is greater than a threshold standard deviation value, TH1, are deemed by the processor 50, 52 and/or 56 at step 156 to have imprecisely determinable charge magnitude values, and the OFR, CM pairs of such charged particles are therefore deemed to be unacceptable. Selection of the threshold value, TH1, will generally depend on a number of factors including the desired accuracy of the charge magnitude values and/or other considerations.

With respect to filtering condition (3), trapped charged particles that have more stable traversal paths within the ELIT 14 will generally have lower standard deviations in their respective f0 (or OFR) than those with less stable traversal paths. In the ELIT 14, for example, highly stable charged particles will generally oscillate back and forth between the ion mirrors M1, M2 with a substantially constant oscillation frequency, whereas less stable and unstable charged particles may deviate from an otherwise constant oscillation frequency by deviating in the ion mirror M1, the ion mirror M2 and/or in the charge detection cylinder, CD, from a flight path that is on or near the longitudinal axis 20. In this regard, charged particles having a standard deviation SDOF that is greater than a threshold standard deviation value, TH2, are deemed by the processor 50, 52 and/or 56 at step 152 to be unstable and therefore unacceptable. Selection of the threshold value, TH2, will generally depend on a number of factors relating to the particular structure and operation of the ELIT 14, and will typically be determined empirically.

With respect to filtering condition (4), HR is illustratively used to distinguish peak signal values from noise. The magnitude of the third harmonic ratio should, in theory, be 0.333 of the magnitude of the fundamental frequency. In this regard, charged particles having HR greater than +/−TH3 of 0.333 are determined by the processor 50, 52, and/or 56 to be unacceptable. Selection of the threshold value, TH3, will generally depend on a number of factors relating to the particular structure and operation of the ELIT 14, and will typically be determined empirically.

In any case, OFR, CM pairs lost before the end of the ITE, that have charge magnitude standard deviations SDC greater than TH1, that have oscillating frequency standard deviations SDO greater than TH2, or that have HR greater than TH3 from 0.333 are rejected by the processor 50, 52 and/or 56, and all others are stored in the filtered file FF. The quality check thus rejects from the filtered file FF all ions that undergo a significant change during the course of the measurement process either spontaneously (loss of charge, mass, or both) or from ion-ion interactions within the ELIT 14.

When trapping and simultaneously measuring charge detection information for multiple charged particles in the CDMS 10 as described above, the OFR, CM pairs contained with the filtered file FF following execution of step 112 are those used by the processor 50, 52 and/or 56 at step 118, e.g., for 1 or more iterations of the process 100, to compute and represent the charged particle spectral distribution, i.e., ion mass-to-charge ratio (m/z), ion charge magnitude, ion mass, etc. In embodiments in which the process 100 is executed only for a single iteration, the process 100 advances from step 112 directly to step 118, otherwise the process 100 loops from step 112 back to step 102 for each iteration of a multi-iteration execution of the process 100.

### STFT Computation and Analysis Process

As described above with respect to step 112 of the process 100, the charge magnitude (CM) of each ion identified in the FEFT is determined from the averaged magnitudes of the fundamental frequency of that ion in each of the STFTs. The accuracy of each such fundamental frequency magnitude determination thus bears on the accuracy of the respective CM value. Due to the discrete nature of the FFT frequency bins, however, the fundamental frequency magnitude can be underestimated if the fundamental frequency peak does not align with a frequency bin of the FFT. This potential error source is referred to herein as a “scalloping loss.”

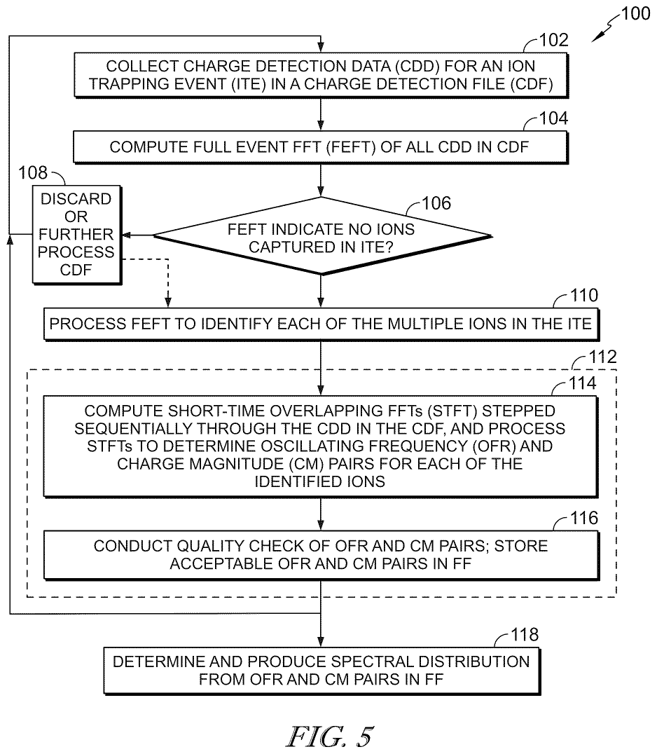

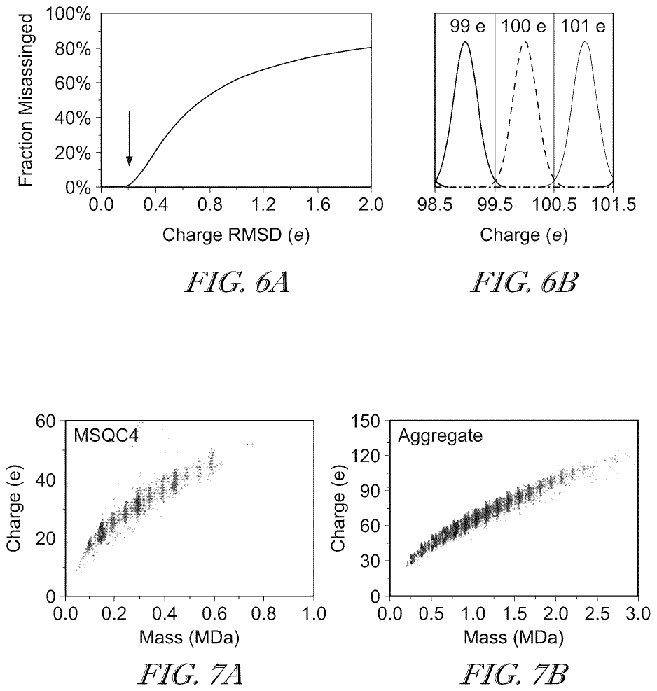

Moreover, since charge is quantized, if the charge measurement precision is very high, e.g., 0.1 e RMSD, the measured charge can be rounded to the nearest integer with high accuracy. However, if the precision of the charge measurements is low, e.g., 0.4 e RMSD, and they are rounded, some ions will be assigned to the wrong charge states. By example, FIG. 6A shows the fraction of misassigned ions plotted against the charge RMSD. With a charge RMSD of 0.2 e (indicated by the arrow) the fraction of ions that are misassigned becomes negligible. The fraction misassigned rises rapidly with increasing charge RMSD, reaching 20% at 0.4 e. FIG. 6B shows an example charge spectrum measured with a charge RMSD of 0.2 e. The peaks are almost completely baseline resolved. A charge RMSD of 0.2 e is therefore illustratively set as a charge precision target as this provides sufficient resolution to assign ions to the correct charge state with low error rate.

In CDMS, the precision of the charge measurement is limited by electrical noise, so the charge RMSD is related to the trapping time (of the trapping event ITE) according to,

$$Charge RMSD ∝ \frac{noise}{\sqrt{trapping time}} . \qquad ( 2 ) .$$

In principle, the trapping time can be adjusted to achieve a charge RMSD of 0.2 e. Illustratively, a charge RMSD of 0.2 e with the CDMS 10′ illustrated in FIG. 2 and described above can be achieved with a trapping time of around 1.5 s according to equation 2.

A primary metric for evaluating STFT computation methods is charge RMSD since this has a direct bearing on charge measurement precision as just discussed. However, because ion mass determination precision is dependent upon uncertainties in both charge magnitude and oscillation frequency measurements according to equation 1 above, precision of oscillation frequency measurements is likewise a primary consideration in evaluating STFT computation methods.

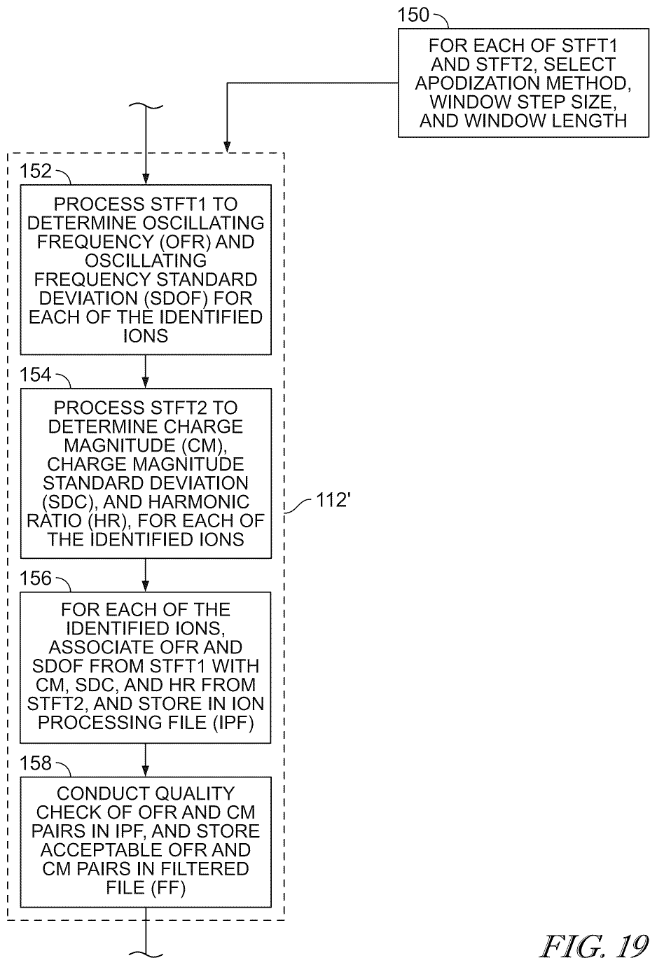

In the following description, several different STFT apodization methods and method parameters are evaluated with the goal of determining one or more such methods and method parameters which optimize, and perhaps maximize, precision of each the charge magnitude and oscillating frequency determinations. Conclusions drawn from such evaluations will lead to another embodiment of an STFT computation and analysis process which may replace step 112 in the process 100 illustrated in FIG. 5 and described above, in which dual STFT processes will be executed by the processor 50, 52, and/or 56; one optimized for charge magnitude precision and the other optimized for oscillating frequency precision. The results of each process will be merged into a single set of charge magnitude (CM) and oscillating frequency (OFR) pairs in which the CM values will be taken from the STFT process optimized for charge magnitude precision and the OFR values will be taken from the STFT process optimized for oscillating frequency precision. Such CM and OFR pairs from this merged set will then be stored in the filtered file FF, and will be used to determine one or any combination of charge magnitude, mass-to-charge ratio, and mass at step 118 for each of the ions in the filtered file FF, the result of which be used to produce the spectral distribution. A flowchart of this new embodiment of the STFT computation and analysis process is depicted by example in FIG. 19, and will be described in detail below.

Such evaluations are illustratively conducted using a variety of different samples to provide data sets for comparison between the different methods. Measurements of such samples are illustratively carried out using the CDMS 10′ of FIG. 2 equipped with an ELIT 14 which provides for an m/z resolving power of 700 and which can achieve the target charge RMSD of 0.2 e with a 1.5 s trapping time. The samples evaluated illustratively include MSQC4, a monoclonal antibody standard, hepatitis B capsids assembled from truncated core protein (Cp149), DNA plasmid pUC19, and encapsulins (protein nanocages) His Switch and TRP. Prior to electrospray using the from the ESI source 24 (FIG. 2), the samples were buffer exchanged from their storage buffers into ammonium acetate solutions using Micro Bio-Spin columns (Biorad, 7326221). A summary of the sample concentrations before exchange into ammonium acetate and the ammonium acetate concentrations used are given in Table 1 below. For MSQC4 two ammonium acetate concentrations of 200 mM and 20 mM were used. The lower salt concentration resulted in aggregation, leading to a broad distribution of mass peaks extending to beyond 2 MDa. The MSQC4 aggregates and pUC19 were electrosprayed using a robotic electrospray source 24, and the other samples were electrosprayed from pulled quartz capillaries 250 nm in diameter.

TABLE 1

| | | | Ammonium Acetate | Electrospray |
|---|---|---|---|---|
| Sample | Concentration | | Concentration | Source |
| MSQC4 | 1 | mg/ml | 200 mM | 250 nm pulled tip |
| MSQC4 | 1 | mg/ml | 20 mM | NanoMate |
| Aggregate | | | | |
| TRP | 0.4 | mg/ml | 20 mM | 250 nm pulled tip |
| His-Switch | 0.33 | mg/ml | 100 mM | 250 nm pulled tip |
| Cp149 | 26 | μM | 200 mM | 250 nm pulled tip |
| pUC19 | 50 | μg/ml | 20 mM | NanoMate |

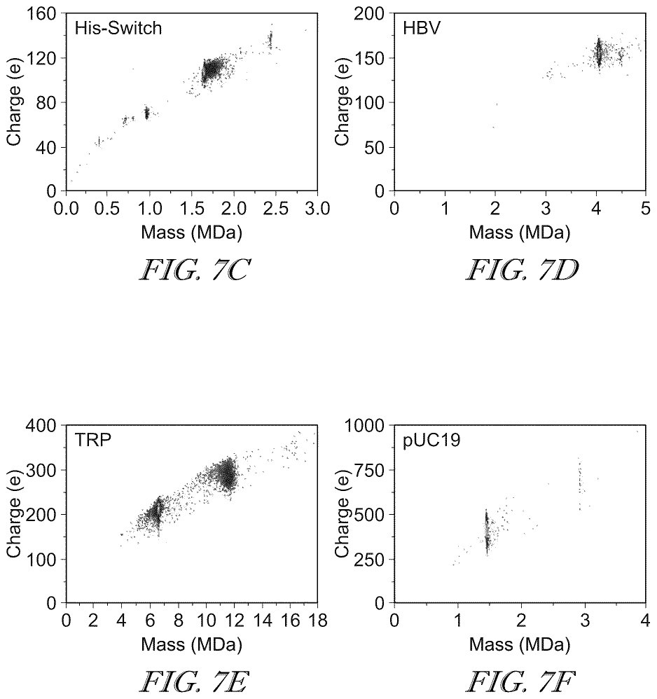

Multiple iterations of the process 100 of FIG. 5 using a conventional STFT method were conducted for each of the above six samples. The results, illustrated by example in FIGS. 7A-7F, are provided to demonstrate the range of charges and masses respectively represented by these samples which are used to evaluate the various STFT computation and analysis methods as described below.

### STFT Apodization Methods

In the implementation of any STFT method, windowing parameters can be selected and/or adjusted to optimize the performance of the method. Two quantities that are often used to characterize apodization methods are equivalent noise bandwidth (ENBW) and susceptibility to scalloping loss. The ENBW is the width (usually in terms of FFT bins) of a rectangular filter that accumulates the same noise as the chosen window. Often the primary concerns are to maximize the frequency resolution and detect small signals. A low ENBW lowers the noise floor allowing small signals to be detected and allows signals with similar oscillation frequencies to be differentiated. However, a low ENBW is often paired with an increased scalloping loss. This is not a major concern if frequency resolution and the detection of small signals are the only goals. However, for CDMS the charge is determined from the amplitude of the peak in the frequency domain. Thus, an accurate determination of the amplitude is critical to obtaining a precise charge, and the amplitude is influenced by scalloping loss (the underestimation of the peak maximum due to the discrete nature of the FFT frequency bins as described above). Scalloping loss can be mitigated by parabolic interpolation; however, the most reliable charge determination will result when the correction provided by parabolic interpolation is small.

As noted above, significant variations in the charge, m/z ratio, or harmonic ratio as the STFTs are stepped through the time domain data are taken to indicate that the signal is unreliable, and results from these ions are discarded. To avoid discarding ions unnecessarily it is important that the windowing method employed does not contribute to the variations. Scalloping loss, for example, could lead to step-to-step variations in the charge.

To investigate the sensitivity to windowing method and determine the best approach for the analysis of CDMS data a variety of different apodization methods are used to analyze the CDMS signals. The windowing methods used in this investigation are summarized below in Table 2. Flat-top and rectangle were chosen as they are at the extremes of the ENBW and scalloping loss spectrums.

TABLE 2

| | | Scalloping |
|---|---|---|
| Window | ENBW | Loss |
| Rectangle | Lowest | Highest |
| Gaussian | Medium | Medium |
| Blackman | High | Low |
| Harris | | |
| Flat-Top | Highest | Lowest |

Blackman Harris was chosen because it has a low scalloping loss. Finally, Gaussian was chosen because it is an adjustable windowing technique where changing the standard deviation allows it to be configured to resemble either rectangle or flat-top. Here a standard deviation of 0.45 was used which places the Gaussian window between rectangle and Blackman-Harris in terms of ENBW and scalloping loss.

In addition to the windowing method, two other parameters can be optimized to maximize precision and minimize analysis time: the window length and the window step size (the spacing between subsequent windows). Both of these parameters affect the overlap between neighboring windows. The window length and the windowing method are coupled to one another, and thus these two parameters are considered together. However, the window step size can be considered separately.

### Effect of Window Step Size on STFT Analysis

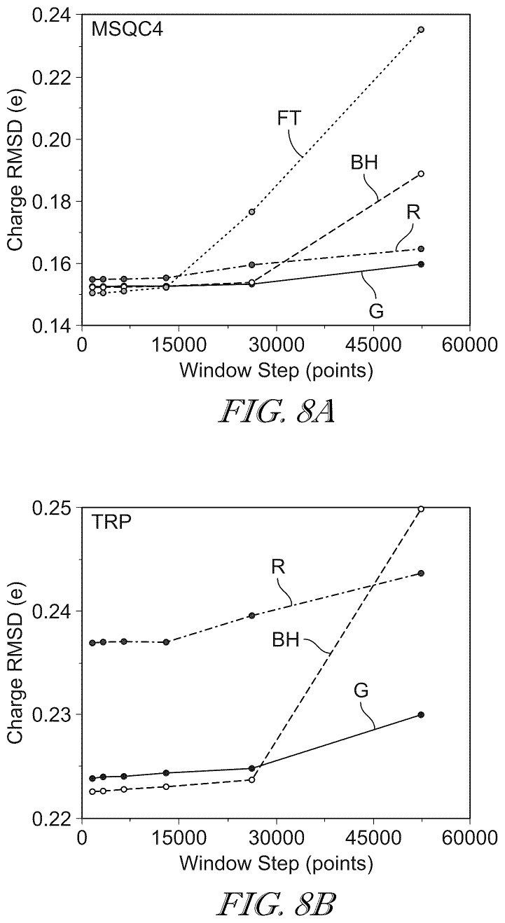

To evaluate the effect of window step size on charge magnitude measurements, the effects of different window step sizes on the charge RMSD was monitored. Results are shown in FIG. 8A for the MSQC4 data set (representative of a low charge, low m/z sample) and in FIG. 8B for the TRP data set (a high charge, high m/z sample). The results in FIGS. 8A and 8B were obtained with a window length of 65536. The STFT input files were zero filled to 218 points and parabolic interpolation was used to improve peak precision and amplitude accuracy. Window window step sizes of 1638, 3277, 6554, 13108, 26216 and 52432 points were tested on these data sets for each of the four apodization methods Gaussian, Rectangle, Blackman-Harris, and Flat-Top, respectively labeled G, R, BH, and FT in each of FIGS. 8A and 8B. The largest window step is 52432 and smaller steps decrease by a factor of 2.

The dependence of the charge RMSDs for both MSQC4 (FIG. 8A) and TRP (FIG. 8B) show the same basic trends with window step size. The lowest charge RMSDs are obtained with the shorter window lengths. Increasing the window step size causes the charge RMSD to gradually increase and then for larger step sizes the charge RMSDs increase much more rapidly. There are no results in FIG. 8B for flat-top apodization because with a window length of 65536, ions did not make it through the filtering process (discussed below).

With the largest window step size (52432) there is 20% overlap between neighboring windows. As the step size decreases the data is sampled in multiple windows. This oversampling leads to the reduction in the charge RMSD. However, the improvement on going to shorter and shorter step sizes ultimately becomes vanishingly small. Reducing the window step size increases the number of STFTs that are performed, increasing the analysis time. With the short step sizes, the analysis time exceeds the trapping time, so that data analysis cannot keep up with data acquisition. As discussed elsewhere, for example, maintaining real-time analysis is desirable to allowing the user to optimize experimental conditions, instrument settings, and information content. In any case, a step size of 6554 offers almost no degradation in the charge determination while maintaining real time analysis even for high-throughput CDMS where multiple ions are trapped simultaneously. In the remainder of the investigations described below, the step size is therefore fixed at 6554.

### Effect of Window Length and Apodization Method on STFT Analysis

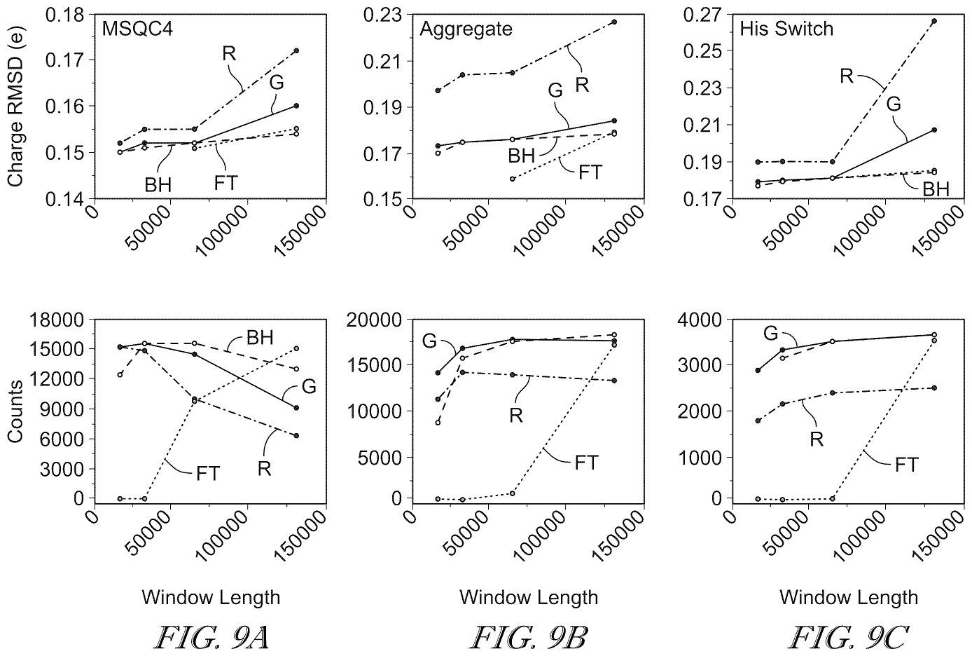

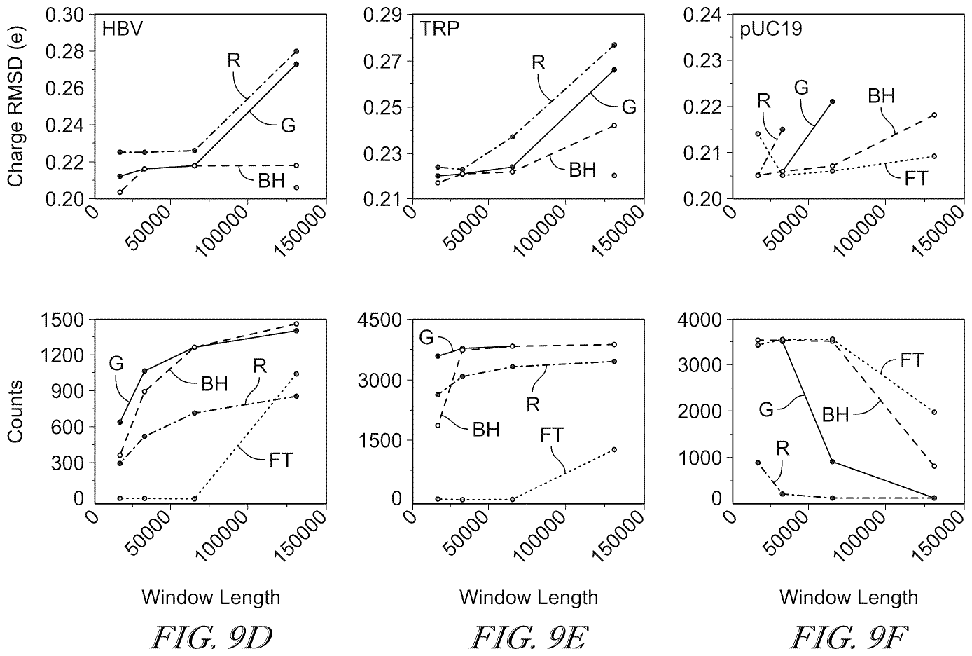

The effects of the window length and of the apodization method on the STFT analysis of CDMS data are coupled to one another as described above, and so they are considered together here. Window lengths of 8192, 16384, 32768, 65536 and 131072 points were investigated for each of the four apodizations methods (rectangle (R), Gaussian (G), Blackman-Harris (BH), and flat-top (FT)). As before, the STFT input files were zero filled to 218 points and parabolic interpolation was used to improve peak precision and amplitude accuracy. The results are shown in FIGS. 9A-9F. FIG. 9A represents MSQC4, wherein the top plot shows the charge RMSDs for each apodization method, and the bottom plot shows the number of ions detected (count), each plotted against window length. FIGS. 9B-9F show the same data for each of the Aggregate, His Switch, HBV, TRP, and pUC19 samples, respectively. With a window size of 8192, no ions made it through the filtering step for any of the apodization methods employed. This is primarily because of the degradation in the S/N ratio that results with a short window, which leads to large variations in the m/z and charge as the STFTs are stepped through the trapping event. The large variations in the STFT m/z and charge values lead, in turn, to large m/z and charge standard deviations for the trapping event, so that the ion is discarded.

The results are shown in FIGS. 9A-9F in order of increasing charge where MSQC4 has the lowest charge and pUC19 has the highest charge. Generally, charge and m/z are roughly correlated (the charge and m/z increase in concert). The exception is pUC19 where the charge is high, and the m/z is low.

Several trends are evident in the data in FIGS. 9A-9F. In nearly all cases, a decreased window length is directly correlated with a decreased charge RMSD. The decrease in charge RMSD can be attributed to a reduction in scalloping loss with smaller window lengths. Smaller windows lead to broader peaks in the frequency spectrum that extend over more frequency bins. While parabolic interpolation may reduce scalloping loss, the best results are obtained when the correction is small. Broader peaks with flatter centers provide a more consistent charge determination.

The differences between the charge RMSDs for the four apodization methods can also be explained by susceptibility to scalloping loss. Rectangle (which has the highest scalloping loss in Table 2) almost always has the highest charge RMSD regardless of the window length. Rectangle also has the lowest ENBW. While having a low ENBW is important for S/N and ion detection, the performance of the charge sensitive amplifiers used for CDMS has dramatically improved, so the need for a low ENBW has been reduced. Even for samples with relatively low charge (such as MSQC4) the other three windowing methods are better than rectangle. Blackman-Harris and Gaussian (which have low and medium susceptibility to scalloping loss in Table 2) have roughly the same charge RMSD across the three samples with the lowest charge. For the higher charge samples, the effect of Gaussian's higher susceptibility to scalloping loss becomes apparent and Blackman-Harris outperforms Gaussian. Flat-top has the lowest susceptibility to scalloping loss in Table 2 and outperforms the other windowing methods with respect to the charge RMSD when ions are detected and make it through the filtering step. However, few ions make it through the filtering step with flat-top because of its high ENBW (see below).

Another trend evident in FIGS. 9A-9F is the increase in charge RMSD at short window lengths with increasing charge (the data in FIGS. 9A-9F is organized in order of increasing charge). The results for pUC19 are an exception to this trend. The charge RMSD is limited mainly by electrical noise and its magnitude is largely independent of the charge. However, for most of the samples investigated, the increase in the charge is accompanied by an increase in the m/z ratio and hence a decrease in the oscillation frequency (see Equation 1). The electrical noise increases as the frequency decreases, and this is mainly responsible for the increase in the charge RMSD with charge. The reason that pUC19 does not follow this trend is that it has m/z values that are ten times smaller than the m/z values for TRP, and less than the m/z values for MSQC4. pUC19 adopts extended structures that can accommodate much more charge than the compact (near spherical) structures adopted by the other samples.

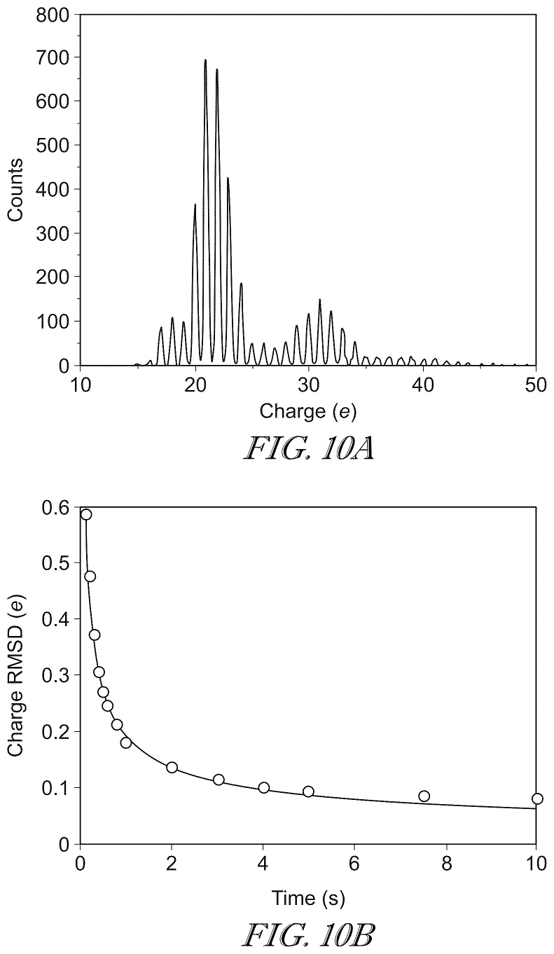

The charge RMSDs for MSQC4 shown in FIG. 9A are the lowest values reported to date. FIG. 10A depicts a charge distribution histogram obtained for the MSQC4 sample using Gaussian apodization with a 32768 window length, showing baseline resolution of the charge states. As also shown in FIG. 9A, charge RMSD is 0.152 e where there is baseline resolution of the charge states. As indicated above, the charge RMSD is mainly determined by the trapping time. The results presented were obtained with a trapping time of 1.5 s. At sufficiently long trapping time it is likely that the charge RMSD is no longer limited entirely by electrical noise, as other factors may come into play. To investigate this further, a function generator was used to apply a 15 kHz signal to an antenna inserted though the field free region of the ELIT 14. The signal amplitude corresponded to an induced charge of around 106 e. Data files were collected for 10 s and then analyzed using Gaussian apodization with a 32768 window length. The same data files were analyzed for a range of different time periods from 0.128 s up to 10 s. The charge RMSDs are plotted in FIG. 10B against time. The points are the RMSDs, and the line is a fit that assumes a square root dependence on time (i.e., the behavior expected if noise determines the RMSD). There is good agreement between the measured values for times <4 s but for longer times (>4s) the points start to move away from the line. This may indicate that other factors are beginning to limit the charge RMSD. But, for trapping times relevant to CDMS (<4 s) electrical noise is indeed the dominant factor. This highlights the benefit of optimizing the data analysis to minimize the trapping time required to achieve charge state resolution.

The number of ions that make it through the filtering process is another important metric to consider when evaluating the various apodization methods. As mentioned above there are three filters applied to the STFT results for each ion, the charge standard deviation, the m/z standard deviation, and the average harmonic ratio should all be within preset limits. FIGS. 9A-9F show the number of ions detected (counts) plotted against window length for the four apodization methods. The results for MSQC4 aggregate, His Switch, HBV, and TRP show similar trends with the counts increasing as the window length increases. The best performing windowing methods (highest counts) are Gaussian and Blackman-Harris. However, MSQC4 and pUC19 show the reverse trend, with the counts generally decreasing as the window length increases.

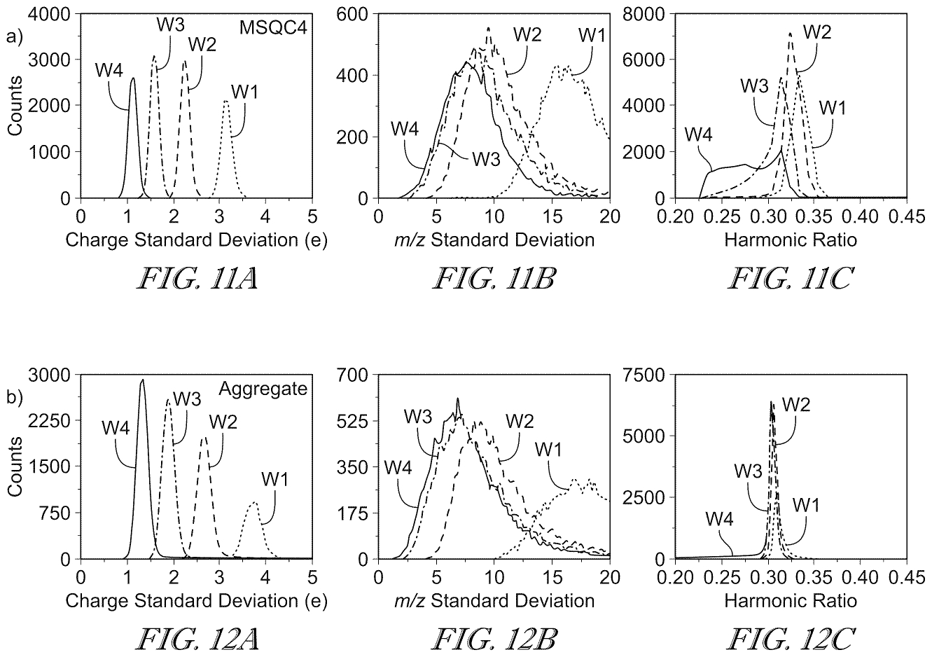

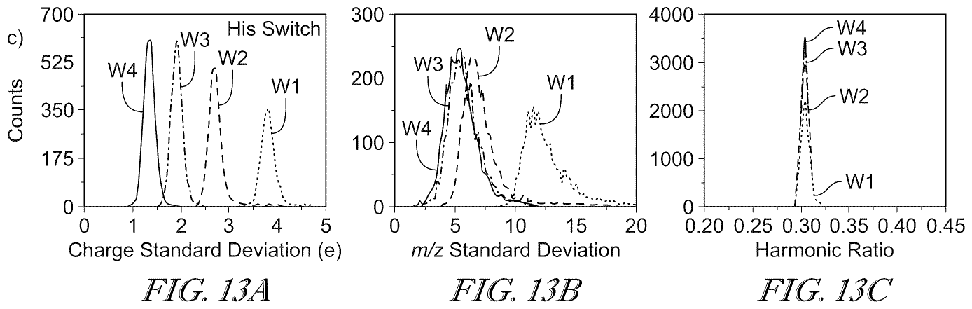

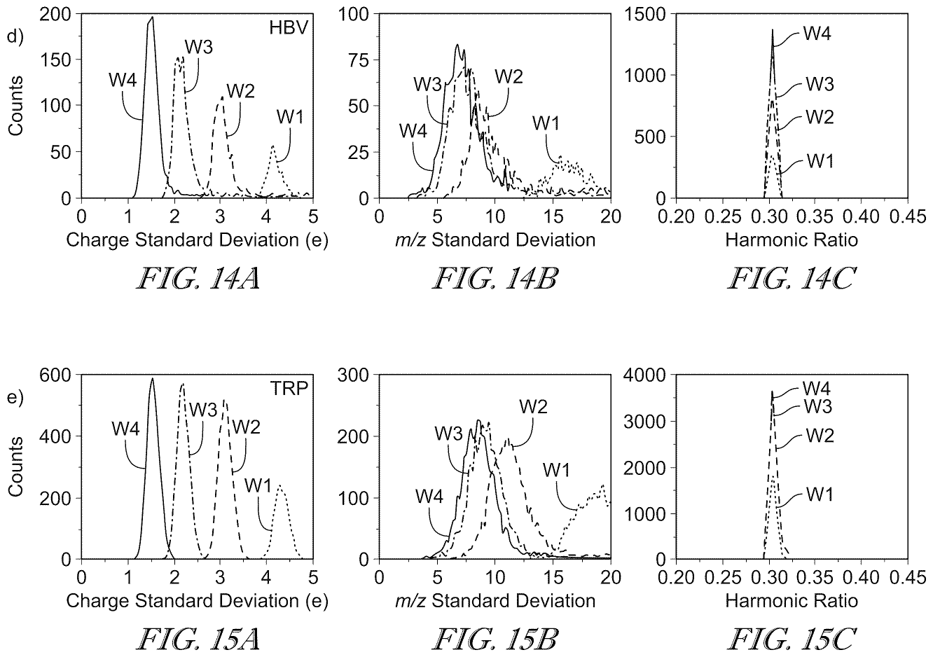

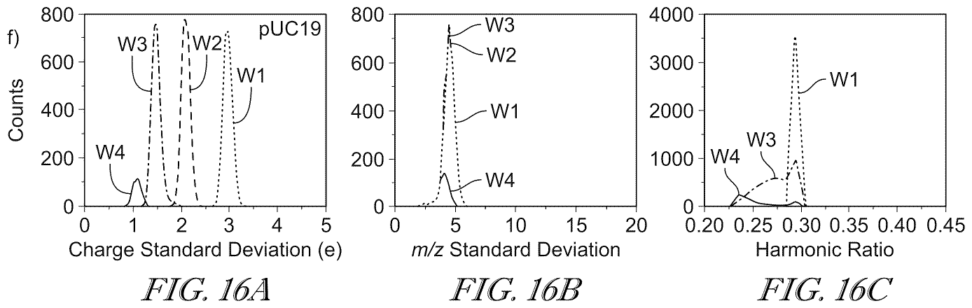

To further understand these trends, FIGS. 11A-11C show histograms of the charge standard deviation, the m/z standard deviation, and the harmonic ratio (HR) respectively for ions that make it through the filtering process for the analysis of the MSQC4 data set using Blackman-Harris apodization with 16384, 32768, 65536 and 131072 window lengths. In each of FIGS. 11A, 11B, and 11C, the window length 16384 is identified as W1, the window length 32768 is identified as W2, the window length 65536 is identified as W3, and the window length 131072 is identified as W4, such that the window lengths increase with increasing window numbers W1-W4. The cut-offs in the filtering process are a charge RMSD<5 e, an m/z RMSD<20, and a harmonic ratio between 0.23 and 0.43 (the expected ratio for a 50% duty cycle is 0.33 as described above). Ions that fall out of any of these ranges are discarded. The charge and m/z standard deviations in FIGS. 11A-11C both improve for longer window lengths. Similar plots for the other sample data sets are shown in FIGS. 12A-16C. They all show the same general trends with the charge and m/z standard deviations improving with longer window lengths. With shorter window lengths it is evident in FIGS. 11A-11C that the m/z cut-off is mainly instrumental in reducing the number of ions that make it through the filtering process. This is generally true for the other samples as well, as depicted in FIGS. 12A-16C, where FIGS. 12A-12C show for the Aggregate sample the same type of data as FIGS. 11A-11C respectively, FIGS. 13A-13C show the same for the His Switch sample, FIGS. 14A-14C show the same for the HBV sample, FIGS. 15A-15C show the same for the TRP sample, and FIGS. 16A-16C show the same for the pUC19 sample. On the other hand, for MSQC4, which also shows a reduction in the ion count at long window lengths, the results in FIGS. 11A-11C show that this is due to the ions failing the harmonic ratio test. There is also a reduction in the ion count at long window lengths for pUC19, and this is also due to ions failing the harmonic ratio test.

The oscillation frequency changes slightly for trapped ions because the ions lose energy while they are trapped. The rate of frequency charge (the frequency slope) is usually larger for higher frequency ions. The change in frequency causes the frequency of the ions to drift between frequency bins, effectively flattening the peak in the FFT. This cannot be corrected by parabolic interpolation. The frequency slope is larger for the third harmonic than the fundamental. So, the magnitude of the third harmonic is generally suppressed more than the magnitude of the fundamental, leading to a decrease in the harmonic ratio. As the window length increases, the frequency drift within the window becomes larger. Thus, this problem emerges for high oscillation frequencies (low m/z) and long window lengths.

Based upon these data, the windowing method and window length both bear on the performance for STFT analysis of CDMS data. While minimizing window length maximizes charge RMSD, increasing the window length generally leads to an increase in the number of ions detected, and it is thus desirable to strike a balance between these conflicting requirements. In the past, Gaussian windowing with a window length of 32768 and window spacing of 6554 was employed in CDMS analysis. However, the windowing method and window length can easily be adapted to maximize ion counts or charge RMSD on a per sample basis as demonstrated by the data in FIGS. 9A-16C.

### Sinc Function Fitting Versus Parabolic Interpolation

Parabolic interpolation has been used on STFT input files to improve peak precision and amplitude accuracy, as described above. In parabolic interpolation, however, only the three highest points for a peak are fit to determine the magnitude and frequency of the peak, whereas for sinc function fitting more points are fit including a significant amount of baseline. In this regard, sinc function fitting is compared to parabolic interpolation for the MSQC4, His switch, HBV, TRP, and pUC19 data sets using Gaussian apodization with window lengths of 16384, 32768, 65536, and 131072, and the results are presented in Table 3 below.

As the data in Table 3 demonstrates, there is no systematic difference in the performance of parabolic interpolation and sinc function fitting. However, because sinc function fitting uses more computer resources and more data around the peak, parabolic interpolation appears to be better suited for high throughput CDMS.

### STFT Frequency Determination

Up to this point, the charge RMSD has been the main metric used to evaluate the various STFT methods for CDMS data analysis. However, both ion

| | Window | Charge RMSD (e) | | | Counts | | |
|---|---|---|---|---|---|---|---|
| Sample | Length | Sinc fit | Parabolic | Difference | Sinc fit | Parabolic | Difference |
| MSQC4 | 16384 | 0.1530 | 0.1527 | −0.0002 | 15331 | 15247 | −84 |
| | 32768 | 0.1551 | 0.1549 | −0.0002 | 14677 | 14824 | 147 |
| | 65536 | 0.1638 | 0.1551 | −0.0087 | 9966 | 9957 | −9 |
| | 131072 | 0.1733 | 0.1751 | 0.0018 | 6352 | 6308 | −44 |
| His switch | 16384 | 0.1901 | 0.1895 | −0.0006 | 1863 | 1751 | −112 |
| | 32768 | 0.1902 | 0.1901 | −0.0001 | 2184 | 2117 | −67 |
| | 65536 | 0.1941 | 0.1915 | −0.0026 | 2365 | 2358 | −7 |
| | 131072 | 0.2650 | 0.2663 | 0.0012 | 2445 | 2466 | 21 |
| HBV | 16384 | 0.2209 | 0.2249 | 0.0039 | 362 | 298 | −64 |
| | 32768 | 0.2211 | 0.2253 | 0.0042 | 578 | 520 | −58 |
| | 65536 | 0.2234 | 0.2260 | 0.0027 | 721 | 716 | −5 |
| | 131072 | 0.2801 | 0.2804 | 0.0003 | 817 | 860 | 43 |
| TRP | 16384 | 0.2236 | 0.2243 | 0.0007 | 2114 | 2619 | 505 |
| | 32768 | 0.2229 | 0.2231 | 0.0001 | 3251 | 3081 | −170 |
| | 65536 | 0.2366 | 0.2371 | 0.0004 | 3302 | 3312 | 10 |
| | 131072 | 0.2777 | 0.2778 | 0.0000 | 3329 | 3442 | 113 |
| pUC19 | 16384 | 0.2080 | 0.2049 | −0.0031 | 998 | 819 | −179 |
| | 32768 | 0.2198 | 0.2152 | −0.0045 | 133 | 131 | −2 |
| Average | | | | −0.0003 | | | 2.1 |

change magnitude and ion oscillating frequency (which provides m/z) are required to determine the ion mass. As the mass resolution, determined from m/z and charge magnitude, is thus a combination of the uncertainties in both oscillating frequency and charge magnitude determinations, it is therefore desirable to also determine the oscillation frequency accurately. Ion oscillation frequency is conventionally determined for each STFT step using parabolic interpolation. However, as noted above, the oscillation frequencies of trapped ions drift slightly due to energy loss. Thus, a linear interpolation is performed to determine the frequency at the beginning of the trapping period.

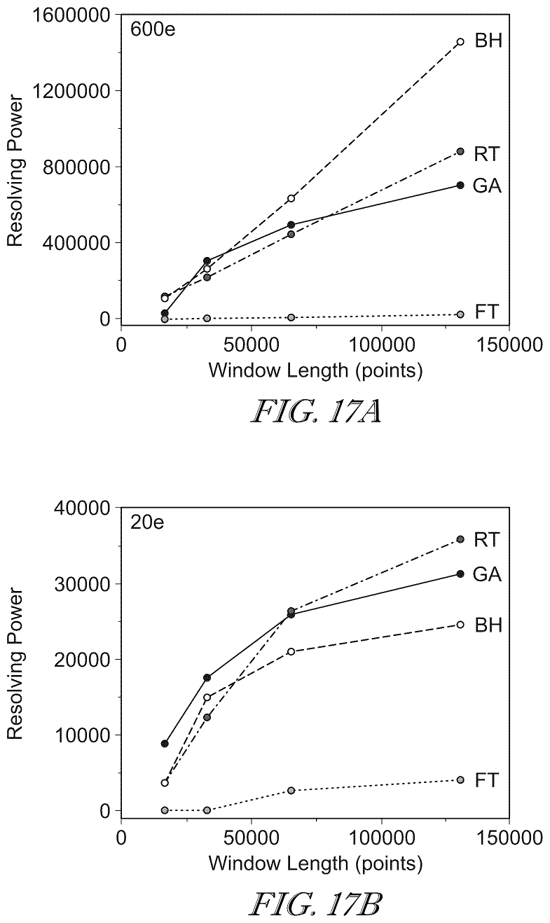

To avoid the complication of the drift in the oscillation frequency, the effect of the apodization method and window length on the oscillating frequency resolving power was investigated using a simulated signal. A function generator was used to apply a 15 kHz signal to an antenna inserted though the field free region of the ELIT 14. Around 10,000, 150 ms trapping events, each containing a simulated ion signal of roughly 600 e or 20 e were analyzed. The frequency resolving power was determined from f/Δf where Δf is the full width at half maximum of the frequency distribution from the 10,000 determinations. The results are summarized in FIGS. 17A and 17B which show plots of the frequency resolving power against window length for the four apodization schemes discussed herein. For both the 600 e input signal (FIG. 17A) and the 20 e input signal (FIG. 17B), the resolving power generally increases with increasing window length. In all cases, the resolving power obtained with a 20 e signal input is substantially smaller than that obtained with the 600 e input signal. Indeed, the highest resolving power obtained with the 600 e signal is nearly 40× higher than the highest resolving power attainable with the 20 e signal. This difference is mainly due to the decrease in the signal to noise ratio with the 600 e input signal, which leads to more random variations in the frequencies determined from parabolic interpolation.

Comparing the four apodization techniques in FIGS. 17A and 17B, the worst performance is obtained from flat-top (FT), and the poor performance of FT can be attributed to its high ENBW. The ENBW is also responsible for other trends evident in FIGS. 17A and 17B. While BH has the best performance for the 600 e input signal at longer window lengths, rectangle has the best performance for the 20 e input signal. Rectangle also has the lowest ENBW, whereas BH has a high ENBW. The best performance is obtained from rectangle, which has the lowest ENBW, and BH which has a high ENBW (second worst, just behind flat-top—see Table 2).

The best resolving power observed in FIGS. 17A and 17B is in excess of 1.4×10⁶ for the 600 e input signal analyzed with BH apodization and a window length of 131072. The worst resolving power of 2629 was obtained using flat-top for a 20 e input signal using a window length of 65,536. The resolving power of 2629 significantly exceeds the maximum resolving power obtained experimentally with the ELIT 14, which is approximately 700 as noted above. However, higher resolution ELITs have been developed. However, much higher resolution ELITs are expected in the near future, and in any such improved ELITs the apodization method and window length method may require consideration so as not to limit the m/z resolving power of such ELITs with resolution-limiting apodization and/or window length methods.

### Dual STFT Computation and Analysis Process

As is evident from the foregoing analysis, apodization method and window length both bear on the precision of charge magnitude and oscillating frequency determinations, and are in some cases inconsistent in terms of precision as between the two determinations. Indeed, window length presents conflicting requirements for the precision of charge magnitude determinations as compared with the precision of oscillating frequency determinations. This is evidenced by the data presented in FIGS. 9A-9F and 17A and 17B which together demonstrate that the lowest charge RMSD determinations are obtained with short window lengths, whereas the highest resolving power m/z values are obtained with long window lengths. Thus, to maximize the accuracy of ion mass measurements and take advantage of the best apodization method and window length for both the charge magnitude and oscillation frequency determinations, a dual-FFT approach is adopted where two separate STFTs are selected and performed; one optimized for ion charge magnitude determinations and the other optimized for oscillating frequency determinations.

With respect to oscillating frequency determinations, the data presented in FIGS. 17A and 17B reveals that the apodization method with the highest oscillating frequency resolving power, i.e., with the greatest oscillation frequency precision, depends, at least in part, on the charge magnitude values of the sample ions. With samples having highly charged ions, for example, BH apodization gives the best performance, whereas rectangle apodization provides the best performance with samples having ions with low charge magnitudes. With both apodization methods, the highest resolving power m/z values are obtained with long window lengths as noted above. Based on the parameters which produced the data in FIGS. 17A and 17B, for example, the longest window length of 131072 should be used to optimize the precision of the oscillation frequency determinations. Such a long window length also benefits the filtering procedure because the largest windows yield the smallest step by step deviations. Thus, depending on the charge level of the sample ions, the STFT process used for oscillating frequency determinations uses the longest practical window length (e.g., the longest window length above which produces diminishing returns and/or adversely affects one or more other operating parameters), and should employ the apodization method which produces the highest oscillating frequency resolving power.

With respect to charge magnitude determinations, a balance may be struck between the dual goals of acceptable charge RMSD (e.g., at or below the 0.2 e target) and maximum ion throughput (i.e., the number of ions that pass the filtering procedure). To maximize the number of ions that pass the filtering procedure, a long window length is preferred. However, a long window length degrades the charge RMSD, as demonstrated in FIGS. 9A-9F, whereas short window lengths result in the lowest charge RMSD values. As a compromise between these competing goals, a window length of 32678 is suggested for the parameters used to produce the data in FIGS. 9A-9F. The 32678 window length represents the second shortest window length tested. The shortest window length of 16384 offers a marginal improvement in charge RMSD, with a substantial decrease in the number of ions that are retained through the filtering procedure as compared with the window length of 32678.

With respect to window step size, the data presented in FIGS. 8A and 8B reveals that all of the apodization methods produce the lowest respective charge RMSD values with window step sizes below a threshold value. However, the improvement step sizes less than this threshold value produce diminishing returns, as reducing the window step size increases the number of STFTs that are performed, thereby increasing the analysis time. With the parameters used to produce the data of FIGS. 8A and 8B, a step size of 6554, which represents the third lowest step size used, offers almost no degradation in the charge determination while maintaining acceptable analysis time, and is thus appropriate for both of the STFT processes.

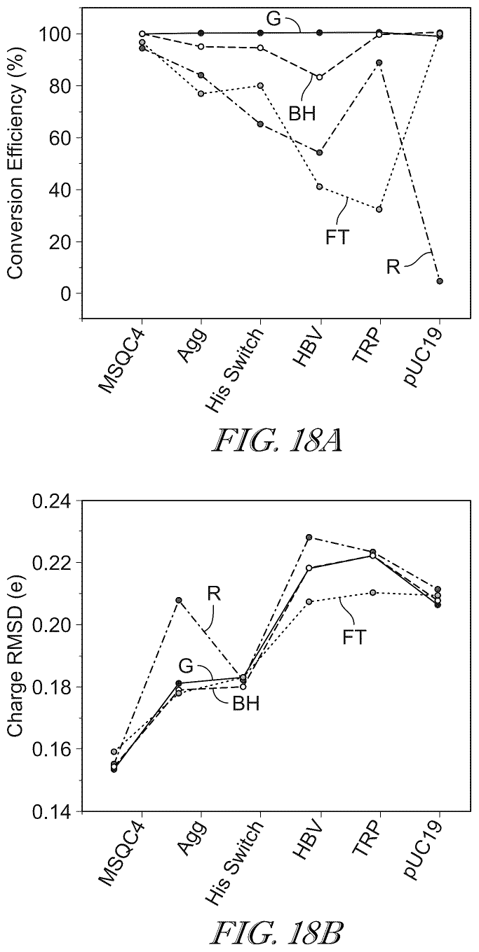

By using both of the above STFTs, each optimized as described for one or the other of charge magnitude and oscillating frequency determination precision, and then following the same data analysis workflow described above with respect to FIG. 5, results may be obtained that have low charge RMSD and increased ion retention, but that do not have artifacts associated with high/low frequency and charge combinations for any sample. Results for example dual-STFT runs are shown in FIGS. 18A and 18B. Compared to the results in FIGS. 9A-9F, the dual-STFT approach offers RMSDs as low as those with the 32768 window length and with overall measurement precision and ion counts of that of the 131072 window length. The conversion efficiency (the number of good ion signals found by the analysis program using a particular window divided by the maximum number found for that sample with all four windows) is a measure of how well the CDMS signals are converted into useful output. In FIG. 18A, the most notable change with the dual STFT approach is that the conversion efficiency is more stable. This is particularly noteworthy for flat-top, which previously had very low ion counts for many samples (see FIGS. 9A-9F). With dual STFT analysis, flat-top achieves a much higher conversion efficiency due to the reduced m/z standard deviations that no longer causes ions to be filtered. In addition, the charge RMSD still follows the trends seen in FIGS. 9A-9F with flat-top starting to outperform other window methods for samples of low frequency and high charge (HBV, TRP). Based upon the information shown in FIGS. 18A and 18B, Gaussian is the optimum apodization technique overall due to its high conversion efficiency across the board as well as low or lowest charge RMSD. Dual-FFT analysis of CD-MS data thus offers optimized charge and frequency determinations to further improve resolution.

Referring now to FIG. 19, a flowchart is shown illustrating an embodiment of a dual-STFT computation and analysis process 12′ that may be substituted for the STFT computation and analysis process 12 in the charge detection data analysis process 100 illustrated in FIG. 5. As such, the process 12′ is illustratively stored in memory as described above with respect to the STFT process 12, and is executable by the processor 50, 52, and/or 56 as also described with respect to the process 12.

Prior to the first execution of step 112′ in the process 100 illustrated in FIG. 5, the features of each of the two STFT process, STFT1 and STFT2, are selected at step 150. For purposes of this description, STFT1 is the STFT computation process that is to be optimized for oscillating frequency determination precision, and STFT2 is the STFT computation process that is to be optimized for charge magnitude determination precision, as these concepts are described above. The features of each STFT1 and STFT2 to be selected at step 150 illustratively include, but are not necessarily limited to, apodization method, window step size, and window length, as these terms are described above.

For STFT1, the choice of apodization method may be driven solely by a desire to maximize oscillating frequency determination precision. If so, the sample to be analyzed by the CDMS 10, 10′ should be considered as to the magnitudes of charge expected to be produced during ionization of the sample (e.g., via electrospray or other ionization process). If the sample ions are expected to be highly charged, for example, a fitting choice of apodization methods is the Blackman Harris (BH) apodization method, whereas the rectangle apodization method is more appropriate if the sample ions are expected to have comparatively low charge magnitudes, as discussed above. If, on the other hand, the choice of apodization method is driven by a desire for precision in oscillating frequency determinations as well as high conversion efficiency, or if the choice of apodization method is driven solely by a desire to maximize oscillating frequency determination precision but the sample ions are expected to have mid-range charge magnitudes (i.e., neither very high nor very low charge magnitudes), the Gaussian apodization method may be appropriate. It will be understood that other considerations may drive, or have bearing on, the choice of apodization method, and such other considerations may result in an apodization selection different than those just described. It will be further understood that other apodization methods not described herein may alternatively be considered and selected for desirable features thereof.

The choice of window step size for STFT1 may depend on the particular apodization method selected. As briefly described above, a window step size for the selected apodization method which will produce an acceptably low charge RMSD while also maintaining an acceptably low analysis time will likely be most appropriate. However, the window step size may also depend on the sample to be analyzed by the CDMS 10, 10′. For some samples, the selected apodization method may have little relevance to the charge RMSD and analysis time considerations as the charge RMSD differences between the available apodization methods may be minimal in the window step size range of interest, as shown by example in FIG. 8A. For other samples, however, the selected apodization method may be relevant to the charge RMSD and analysis time considerations in the window step size range of interest, as shown by example by the rectangle apodization method for the TRP sample in FIG. 8B. In such cases, selection of the window step size and/or of the selected apodization method may require greater scrutiny. In any case, the selection of window step size should be low enough to achieve a desired charge RMSD while also providing for an acceptable analysis time.

The choice of window length for STFT1 will generally be as high as practicable for the chosen apodization method so as to maximize oscillating frequency resolving power as described above and as shown by example in FIGS. 17A and 17B.

For STFT2, the choice of apodization method may be driven solely by a desire to minimize charge RMSD. If so, the sample to be analyzed by the CDMS 10, 10′ should be considered as the different apodization methods described herein may produce noticeably different charge RMSD values for some samples but not for others, as depicted by example in FIGS. 91-9F. Alternatively, the choice of apodization method may be driven by the dual goals of acceptably low charge RMSD (e.g., at or below the 0.2 e target) while maximizing ion throughput (i.e., the number of ions that pass the filtering procedure), as described above. In this regard, the choice of apodization method is coupled to the window length selection as depicted by example in FIGS. 9A-9F, and a compromise between these competing goals may be achieved via selection of an apodization method and associated window length which provides for an acceptable charge RMSD and an acceptable ion throughput. As also shown by example in FIGS. 9A-9F, the choice of apodization method and window length may also depend on the sample to be analyzed by the CDMS 10, 10′, Alternatively or additionally, the choice of apodization method and window length may be driven, or at least informed, by a combination of acceptable charge RMSD and acceptable conversion efficiency, and in this regard the data illustrated in FIGS. 18A and 18B is informative. As discussed above, the Gaussian apodization method provides for the highest conversion efficiency across all samples tested, which also providing for acceptably low charge RMSD values, and may therefore be an acceptable apodization method choice for STFT2 regardless of sample type.

The choice of window step size for STFT2 requires the same considerations as for STFT1 described above. Indeed, as was the case for the sample tests described above, the same window step size, once selected, was used for both STFT1 and STFT2. In this regard, a window step size for the selected apodization method which will produce an acceptably low charge RMSD while also maintaining an acceptably low analysis time will likely be most appropriate.

It will be appreciated that step 150 provides for many different considerations in the selection of the STFT1 and STFT2 features. In some applications, this may lead to different apodization methods, window lengths, and window step sized for each of STFT1 and STFT2. Other applications may simplify selection of the STFT1 and STFT2 features by focusing on maximizing conversion efficiency while also minimizing charge RMSD. This may lead, for example, to the selection of the Gaussian apodization method with the same window step size for both STFT1 and STFT2, as illustrated by example in FIGS. 18A and 18B, but with a long window length for STFT1 and a short window length for STFT2. Any combination of apodization method, window step size, and window length for STFT1 and/or STFT2, using any one or combination of the considerations discussed above for each, is contemplated by this disclosure. In any case, STFT1 will be optimized for oscillating frequency determination precision, and STFT2 will be optimized for charge magnitude determination precision, as described hereinabove.

Turning now to step 112′ illustrated by example in FIG. 19, step 112′ illustratively begins at step 152 where the processor 50, 52, and/or 56 is operable to process STFT1 to determine an oscillating frequency (OFR) and oscillating frequency standard deviation (SDOF) for each of the ions identified by the full-event FFT at step 110 of the process 100 illustrated in FIG. 5. As with step 114, the processor 50, 52, and/or 56 is operable at step 152 to compute short-time overlapping Fourier transforms (STFT) stepped sequentially through the charge detection data (CDD) in the charge detection file (CDF), i.e., stepped sequentially through CDD as a function of time, using the apodization method, window step size, and window length pre-selected for STFT1 at step 150. The ions identified in the FEFT are tracked as STFT1 is stepped through the charge detection data, and the oscillating frequencies are recorded for each. For each of the identified ions, the processor 50, 52 and/or 56 is illustratively operable at step 152 to determine the oscillating frequency (OFR) of the ion as an average of the fundamental frequencies f0 of that ion over all of the STFT1s which include f0 of that ion. The processor 50, 52, and/or 56 is further operable at step 152 to compute, for each of the identified ions, a standard deviation of the oscillating frequency (SDOF) relative to all of the fundamental frequency values used to compute the respective OFR averages. Thus, for every OFR computed at step 152, there will also be an associated oscillating frequency standard deviation (SDOF).

Following step 152, the processor 50, 52, and/or 56 is operable at step 154 to process STFT2 to determine a charge magnitude (CM), a charge magnitude standard deviation (SDC), and a harmonic ratio (HR) for each of the ions identified by the full-event FFT at step 110 of the process 100 illustrated in FIG. 5. As with step 114, the processor 50, 52, and/or 56 is operable at step 154 to compute short-time overlapping Fourier transforms (STFT) stepped sequentially through the charge detection data (CDD) in the charge detection file (CDF), i.e., stepped sequentially through CDD as a function of time, using the apodization method, window step size, and window length pre-selected for STFT2 at step 150. The ions identified in the FEFT are tracked as STFT2 is stepped through the charge detection data, and the charge magnitudes are recorded for each. For each of the identified ions, the processor 50, 52 and/or 56 is illustratively operable at step 154 to determine the charge magnitude (CM) of the ion as an average of the peak magnitudes of the fundamental frequencies f0 of that ion over all of the STFT2s which include f0 of that ion. The processor 50, 52, and/or 56 is further operable at step 154 to compute, for each of the identified ions, a standard deviation of the charge magnitude (SDC) relative to all of the fundamental frequency peak magnitude values used to compute the respective CM averages, and to compute an average harmonic ratio (HR) for each identified ion as an average over the STFT2s of a ratio of the magnitude of the fundamental frequency and the magnitude of the third harmonic frequency recorded for that ion in each STFT2. Thus, for every CM computed at step 152, there will also be an associated charge magnitude standard deviation (SDC) and an associated harmonic ratio (HR).

Following step 154, the processor 50, 52, and/or 56 is operable at step 156 to combine the results of steps 152 and 154 in an ion processing file IPF. In particular, for each of the identified ions (i.e., identified at step 110 of the process 100 of FIG. 5), the processor 50, 52, and/or 56 is operable at step 156 to associate, i.e., combine, the OFR and corresponding SDOF values from the STFT1 process with the CM and corresponding SDC and HR values from the STFT2 process. At the conclusion of step 156, the ion processing file IPF thus contains, for each of the identified ions, OFR and CM pairs, as well as SDOF, SDC, and HR values associated with each of the pairs, wherein the OFR and SDOF values where generated by the STFT1 process and the CM, SDC, and HR values were generated by the STFT2 process.

Following step 156, the processor 50, 52, and/or 56 is operable at step 158 to conduct a quality check of the OFR and CM pairs in the ion processing file IPF, and to store acceptable OFR and CM pairs in the filtered file FF. Illustratively, the quality check proceeds as described above with respect to step 116 of the process 100, by subjecting the OFR and CM pairs to each of the four different filtering conditions. However, because the values of the OFR and CM pairs were computed at step 112′ with STFT processes optimized for oscillating frequency determination precision and charge magnitude determination precision respectively, it is to be expected that the quality check filtering conditions 2-4 will pass more, perhaps many more, OFR and CM pairs to the filtered file FF as compared to step 112 of the process 100 illustrated in FIG. 5. In any case, with step 112′ substituted for step 112, the remainder of the process 100 illustrated in FIG. 5 is otherwise operable as described above.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected. For example, it will be understood that the ELIT 14 illustrated in the attached figures and described herein is provided only by way of example, and that the concepts and techniques described above may be implemented directly in ELITs of various alternate designs. Any such alternate ELIT design may, for example, include any one or combination of two or more ELIT regions, more, fewer and/or differently-shaped ion mirror electrodes, more or fewer voltage sources, more or fewer voltage signals produced by one or more of the voltage sources, one or more ion mirrors defining additional electric field regions, or the like. As another example, the dual-STFT approach could be extended to adapting, e.g., in real time, the apodization method to the ion signal and the desired outputs. As a further example the dual-STFT approach could be expanded to include dynamic windowing for ions with very low charge. For ions with very low charge, electrical noise causes peaks in the STFT to shift around, and dynamically choosing the window length to minimize such frequency shifts may improve the oscillating frequency resolution. As yet another example, a charge RMSD<0.2 e can be achieved with conventional CDMS by extending the trapping time to improve the charge precision as described briefly above, and in this regard optimizing the data analysis workflow with the dual-STFT approach could allow for the trapping time required to achieve a charge RMSD of <0.2 e to be minimized, thereby reducing the overall measurement time.

What is claimed is:

1. A method of operating a charge detection mass spectrometer including an electrostatic linear ion trap (ELIT) or an orbitrap, the method comprising:
(i) trapping multiple ions, generated from a sample, in the ELIT or orbitrap such that the multiple trapped ions oscillate back and forth through or about a charge detector of the ELIT or orbitrap during an ion trapping event,
(ii) collecting charge detection data resulting from detection of charges induced by the multiple ions on the charge detector over the ion trapping event,
(iii) processing the collected charge detection data with a first short-time overlapping Fourier transform (STFT1) process optimized for oscillating frequency determination precision to determine oscillating frequencies of each of the multiple trapped ions,
(iv) processing the collected charge detection data with a second short-time overlapping Fourier transform (STFT2) process optimized for charge magnitude determination precision to determine charge magnitudes of each of the multiple trapped ions,
(v) populating a filtered file with associated pairs of at least some of the determined oscillating frequencies and determined charge magnitudes, and
(vi) producing a spectral distribution from the filtered file of oscillating frequency and charge magnitude pairs.

2. The method of claim 1, further comprising executing (i)-(v) multiple times, followed by executing (vi) using the filtered file containing oscillating frequency and charge magnitude pairs for all of the multiple executions of (i)-(v).

3. The method of claim 1, further comprising, prior to executing (iii) and (iv), selecting for the STFT1 process a first apodization method configured to optimize the STFT1 process for oscillating frequency determination precision, and selecting for the STFT2 process a second apodization method configured to optimize the STFT2 process for ion charge magnitude determination precision,
wherein (iii) comprises computing a series of STFT1s each with the STFT1 process stepped sequentially through the collected charge detection data using the first apodization method, and determining the oscillating frequencies of each of the multiple trapped ions from the computed series of STFT1s,
and wherein (iv) comprises computing a series of STFT2s with the STFT2 process stepped sequentially through the collected charge detection data using the second apodization method, and determining the charge magnitudes of each of the multiple trapped ions from the computed series of STFT2s.

4. The method of claim 3, further comprising, prior to executing (iii) and (iv), selecting for the STFT1 process a first window step size configured to optimize the STFT1 process for oscillating frequency determination precision, and selecting for the STFT2 process a second window step size configured to optimize the STFT2 process for ion charge magnitude determination precision,
wherein (iii) comprises computing the series of STFT1s with the STFT1 process stepped sequentially through the collected charge detection data using the first apodization method with the first window step size, and determining the oscillating frequencies of each of the multiple trapped ions from the computed series of STFT1s,
and wherein (iv) comprises computing the series of STFT2s with the STFT2 process stepped sequentially through the collected charge detection data using the second apodization method with the second window step size, and determining the charge magnitudes of each of the multiple trapped ions from the computed series of STFT2s.

5. The method of claim 4, further comprising, prior to executing (iii) and (iv), selecting for the STFT1 process a first window length configured to optimize the STFT1 process for oscillating frequency determination precision, and selecting for the STFT2 process a second window length configured to optimize the STFT2 process for ion charge magnitude determination precision,
wherein (iii) comprises computing the series of STFT1s with the STFT1 process stepped sequentially through the collected charge detection data using the first apodization method with the first window step size and with the first window length, and determining the oscillating frequencies of each of the multiple trapped ions from the computed series of STFT1s,
and wherein (iv) comprises computing the series of STFT2s with the STFT2 process stepped sequentially through the collected charge detection data using the second apodization method with the second window step size and with the second window length, and determining the charge magnitudes of each of the multiple trapped ions from the computed series of STFT2s.

6. The method of claim 1, further comprising, prior to executing (iii) and (iv), selecting for the STFT1 process a first window step size configured to optimize the STFT1 process for oscillating frequency determination precision, and selecting for the STFT2 process a second window step size configured to optimize the STFT2 process for charge magnitude determination precision,
wherein (iii) comprises computing a series of STFT1s with the STFT1 process stepped sequentially through the collected charge detection data using the first window step size, and determining the oscillating frequencies of each of the multiple trapped ions from the computed series of STFT1s,
and wherein (iv) comprises computing a series of STFT2s with the STFT2 process stepped sequentially through the collected charge detection data using the second window step size, and determining the charge magnitudes of each of the multiple trapped ions from the computed series of STFT2s.

7. The method of claim 1, further comprising, prior to executing (iii) and (iv), selecting for the STFT1 process a first window length configured to optimize the STFT1 process for oscillating frequency determination precision, and selecting for the STFT2 process a second window length configured to optimize the STFT2 process for charge magnitude determination precision,
wherein (iii) comprises computing a series of STFT1s with the STFT1 process stepped sequentially through the collected charge detection data using the first window length, and determining the oscillating frequencies of each of the multiple trapped ions from the computed series of STFT1s,
and wherein (iv) comprises computing a series of STFT2s with the STFT2 process stepped sequentially through the collected charge detection data using the second window length, and determining the charge magnitudes of each of the multiple trapped ions from the computed series of STFT2s.

8. The method of claim 1, wherein (iii) comprises computing a series of STFT1s with the STFT1 process stepped sequentially through the collected charge detection data, and determining from the computed series of STFT1s the oscillating frequencies of each of the multiple trapped ions and oscillation frequency standard deviations for each of the determined oscillating frequencies,
and wherein (iv) comprises computing a series of STFT2s with the STFT2 process stepped sequentially through the collected charge detection data, and determining from the computed series of STFT2s the charge magnitudes of each of the multiple trapped ions, and charge magnitude standard deviations and harmonic ratios for each of the determined charge magnitudes.

9. The method of claim 8, wherein (v) comprises populating the filtered file only with associated pairs of the determined oscillating frequencies and determined charge magnitudes for which the corresponding oscillating frequency standard deviation is less than a first threshold value, the corresponding charge magnitude standard deviation is less than a second threshold value, and the corresponding harmonic ratio is within a threshold window of a target harmonic ratio value.

10. A charge detection mass spectrometer, comprising:
at least one ion processing stage configured receive ions generated from a sample,
an electrostatic linear ion trap (ELIT) or an orbitrap positioned to receive the generated ions from the at least one ion processing stage,
at least one memory, and
at least one processor configured to execute instructions stored in the at least one memory to cause the at least one processor to (i) control the ELIT or orbitrap to trap multiple ones of the generated ions such that the multiple trapped ions oscillate back and forth through or about a charge detector of the ELIT or orbitrap during an ion trapping event, (ii) collect charge detection data resulting from detection of charges induced by the trapped multiple ions on the charge detector over the ion trapping event, (iii) process the collected charge detection data with a first short-time overlapping Fourier transform (STFT1) process optimized for oscillating frequency determination precision to determine oscillating frequencies of each of the multiple trapped ions, (iv) process the collected charge detection data with a second short-time overlapping Fourier transform (STFT2) process optimized for charge magnitude determination precision to determine charge magnitudes of each of the multiple trapped ions, (v) populate a filtered file with associated pairs of at least some of the determined oscillating frequencies and determined charge magnitudes, and (vi) produce a spectral distribution from the filtered file of oscillating frequency and charge magnitude pairs.

11. The charge detection mass spectrometer of claim 10, further comprising means for detecting charges induced by the trapped multiple ions on the charge detector of the ELIT or orbitrap.

12. The charge detection mass spectrometer of claim 10, wherein the instructions stored in the at least one memory include instructions executable by the at least one processor to cause the at least one processor to execute (i)-(v) multiple times, followed by executing (vi) using the filtered file containing oscillating frequency and charge magnitude pairs for all of the multiple executions of (i)-(v).

13. The charge detection mass spectrometer of claim 10, wherein the instructions stored in the at least one memory include instructions executable by the at least one processor to cause the at least one processor to, prior to executing (iii) and (iv), select for the STFT1 process a first apodization method configured to optimize the STFT1 process for oscillating frequency determination precision, and select for the STFT2 process a second apodization method configured to optimize the STFT2 process for ion charge magnitude determination precision,
wherein the instructions stored in the at least one memory include instructions executable by the at least one processor to cause the at least one processor to execute (iii) by computing a series of STFT1s each with the STFT1 process stepped sequentially through the collected charge detection data using the first apodization method, and determining the oscillating frequencies of each of the multiple trapped ions from the computed series of STFT1s,
and wherein the instructions stored in the at least one memory include instructions executable by the at least one processor to cause the at least one processor to execute (iv) by computing a series of STFT2s with the STFT2 process stepped sequentially through the collected charge detection data using the second apodization method, and determining the charge magnitudes of each of the multiple trapped ions from the computed series of STFT2s.

14. The charge detection mass spectrometer of claim 13, wherein the instructions stored in the at least one memory include instructions executable by the at least one processor to cause the at least one processor to, prior to executing (iii) and (iv), select for the STFT1 process a first window step size configured to optimize the STFT1 process for oscillating frequency determination precision, and select for the STFT2 process a second window step size configured to optimize the STFT2 process for ion charge magnitude determination precision,
wherein the instructions stored in the at least one memory include instructions executable by the at least one processor to cause the at least one processor to execute (iii) by computing the series of STFT1s each with the STFT1 process stepped sequentially through the collected charge detection data using the first apodization method with the first window step size, and determining the oscillating frequencies of each of the multiple trapped ions from the computed series of STFT1s,
and wherein the instructions stored in the at least one memory include instructions executable by the at least one processor to cause the at least one processor to execute (iv) by computing the series of STFT2s with the STFT2 process stepped sequentially through the collected charge detection data using the second apodization method with the second window step size, and determining the charge magnitudes of each of the multiple trapped ions from the computed series of STFT2s.

15. The charge detection mass spectrometer of claim 13, wherein the instructions stored in the at least one memory include instructions executable by the at least one processor to cause the at least one processor to, prior to executing (iii) and (iv), select for the STFT1 process a first window length configured to optimize the STFT1 process for oscillating frequency determination precision, and select for the STFT2 process a second window length configured to optimize the STFT2 process for ion charge magnitude determination precision,
wherein the instructions stored in the at least one memory include instructions executable by the at least one processor to cause the at least one processor to execute (iii) by computing the series of STFT1s each with the STFT1 process stepped sequentially through the collected charge detection data using the first apodization method with the first window length, and determining the oscillating frequencies of each of the multiple trapped ions from the computed series of STFT1s,
and wherein the instructions stored in the at least one memory include instructions executable by the at least one processor to cause the at least one processor to execute (iv) by computing the series of STFT2s with the STFT2 process stepped sequentially through the collected charge detection data using the second apodization method with the second window length, and determining the charge magnitudes of each of the multiple trapped ions from the computed series of STFT2s.

16. The charge detection mass spectrometer of claim 10, wherein the instructions stored in the at least one memory include instructions executable by the at least one processor to cause the at least one processor to, prior to executing (iii) and (iv), select for the STFT1 process a first window step size configured to optimize the STFT1 process for oscillating frequency determination precision, and select for the STFT2 process a second window step size configured to optimize the STFT2 process for ion charge magnitude determination precision,
wherein the instructions stored in the at least one memory include instructions executable by the at least one processor to cause the at least one processor to execute (iii) by computing a series of STFT1s each with the STFT1 process stepped sequentially through the collected charge detection data using the first window step size, and determining the oscillating frequencies of each of the multiple trapped ions from the computed series of STFT1s,
and wherein the instructions stored in the at least one memory include instructions executable by the at least one processor to cause the at least one processor to execute (iv) by computing a series of STFT2s with the STFT2 process stepped sequentially through the collected charge detection data using the second window step size, and determining the charge magnitudes of each of the multiple trapped ions from the computed series of STFT2s.

17. The charge detection mass spectrometer of claim 10, wherein the instructions stored in the at least one memory include instructions executable by the at least one processor to cause the at least one processor to, prior to executing (iii) and (iv), select for the STFT1 process a first window length configured to optimize the STFT1 process for oscillating frequency determination precision, and select for the STFT2 process a second window length configured to optimize the STFT2 process for ion charge magnitude determination precision,
wherein the instructions stored in the at least one memory include instructions executable by the at least one processor to cause the at least one processor to execute (iii) by computing a series of STFT1s each with the STFT1 process stepped sequentially through the collected charge detection data using the first window length, and determining the oscillating frequencies of each of the multiple trapped ions from the computed series of STFT1s,
and wherein the instructions stored in the at least one memory include instructions executable by the at least one processor to cause the at least one processor to execute (iv) by computing a series of STFT2s with the STFT2 process stepped sequentially through the collected charge detection data using the second window length, and determining the charge magnitudes of each of the multiple trapped ions from the computed series of STFT2s.

18. The charge detection mass spectrometer of claim 10, wherein the instructions stored in the at least one memory include instructions executable by the at least one processor to cause the at least one processor to execute (iii) by computing a series of STFT1s with the STFT1 process stepped sequentially through the collected charge detection data, and determining from the computed series of STFT1s the oscillating frequencies of each of the multiple trapped ions and oscillation frequency standard deviations for each of the determined oscillating frequencies,
and wherein the instructions stored in the at least one memory include instructions executable by the at least one processor to cause the at least one processor to execute (iv) by computing a series of STFT2s with the STFT2 process stepped sequentially through the collected charge detection data, and determining from the computed series of STFT2s the charge magnitudes of each of the multiple trapped ions, and charge magnitude standard deviations and harmonic ratios for each of the determined charge magnitudes.

19. The charge detection mass spectrometer of claim 18, wherein the instructions stored in the at least one memory include instructions executable by the at least one processor to cause the at least one processor to execute (v) by populating the filtered file only with associated pairs of the determined oscillating frequencies and determined charge magnitudes for which the corresponding oscillating frequency standard deviation is less than a first threshold value, the corresponding charge magnitude standard deviation is less than a second threshold value, and the corresponding harmonic ratio is within a threshold window of a target harmonic ratio value.

20. A particle mass analysis system, comprising:
the charge detection mass spectrometer of claim 10, and
a charged particle generator configured to generate the ions from the sample and to supply the generated ions to the at least one ion processing stage.
